(19) United States
(12) Patent Application Publication
(10) Pub. No.: US 2026/0181170 A1
(43) Pub. Date: Jun. 25, 2026

(54) PICTURE DECODING METHOD AND APPARATUS, PICTURE ENCODING METHOD AND APPARATUS, AND DEVICE

(71) Applicant: HANGZHOU HIKVISION DIGITAL TECHNOLOGY CO., LTD., Hangzhou (CN)

(72) Inventors: Yucheng SUN, Hangzhou (CN); Fangdong CHEN, Hangzhou (CN); Li WANG, Hangzhou (CN); Xiaoyang WU, Hangzhou (CN)

(21) Appl. No.: 19/129,401

(22) PCT Filed: Jan. 12, 2024
(86) PCT No.: PCT/CN2024/072128

§ 371 Date: May 13, 2025

(30) Foreign Application Priority Data
Nov. 14, 2022 (CN) 202211419754.1

(51) Int. Cl. H04N 19/44; H04N 19/67

(52) U.S. Cl. CPC H04N 19/44; H04N 19/67

(57) ABSTRACT

The present disclosure provides a picture decoding method and apparatus, a picture encoding method and apparatus, and a device. The picture decoding method comprises: when permission protection is enabled, determining one or more target region categories corresponding to a target permission level (301); and decoding a current coding unit according to the one or more target region categories (302). With the technical solutions of the present disclosure, the permission protection of various types of information (e.g., a license plate, a local region of a human body, a screen, text, etc.) in a picture can be performed, thereby improving data security.

### TECHNICAL FIELD

The present disclosure relates to the technical field of encoding/decoding, and in particular, to a picture decoding method and apparatus, a picture encoding method and apparatus, and a device.

### BACKGROUND

To save space, video pictures are transmitted after being coded, and complete video coding may include processes such as prediction, transform, quantization, entropy coding, and filtering. For a prediction process, the prediction process may include intra prediction and inter prediction. The inter prediction refers to prediction of a current pixel by using pixels from nearby already-encoded pictures according to temporal correlation in the video, so as to effectively eliminate temporal redundancy in the video. The intra prediction refers to prediction of a current pixel by using pixels from already-encoded blocks in the current picture frame according to spatial correlation in the video, so as to eliminate spatial redundancy in the video. For both the intra prediction and the inter prediction, the decoder side may reconstruct a complete video picture, and the user may view the complete video picture. However, after the decoder side reconstructs the complete video picture, the complete video picture may present all permission information, e.g., license plate information, human body local region information, screen information, etc., which would lead to security risks, and thus permission protection is needed.

### SUMMARY

In view of this, the present disclosure provides a picture decoding method and apparatus, a picture encoding method and apparatus, and a device, so that permission protection can be performed on various information (e.g., a license plate, a local region of a human body, a screen, text, etc.) of pictures, thereby improving data security.

The present disclosure provides a picture-based decoding method, applied to a decoding device, where the method includes:
when permission protection is enabled, determining one or more target region categories corresponding to a target permission level; and
decoding a current coding unit according to the one or more target region categories.

The present disclosure provides a picture-based encoding method, performed by an encoding device, where the method includes:
in response to determining that permission protection is enabled, determining one or more target region categories; where the target region category is a region category corresponding to a first permission level and not corresponding to a second permission level; and
encoding a current coding unit according to the one or more target region categories.

The present disclosure provides a picture-based decoding apparatus, applied to a decoding device, where the apparatus includes:
a memory, configured to store video data;
a decoder, configured to:
when permission protection is enabled, determine one or more target region categories corresponding to a target permission level; and
decode a current coding unit according to the one or more target region categories.

The present disclosure provides a picture-based encoding apparatus, applied to an encoding device, where the apparatus includes:
a memory, configured to store video data;
an encoder, configured to:
in response to determining that permission protection is enabled, determine one or more target region categories; where the target region category is a region category corresponding to a first permission level and not corresponding to a second permission level; and
encode a current coding unit according to the one or more target region categories.

The present disclosure provides a decoding device, including: a processor and a machine-readable storage medium, where the machine-readable storage medium stores machine-executable instructions executable by the processor; and the processor is configured to execute the machine-executable instructions to implement the foregoing picture decoding method.

The present disclosure provides an encoding device, including: a processor and a machine-readable storage medium, the machine-readable storage medium storing machine-executable instructions executable by the processor, and the processor is configured to execute the machine-executable instructions to implement the foregoing picture encoding method.

It may be seen from the foregoing technical solutions that, in the embodiments of the present disclosure, when permission protection is enabled, a target region category corresponding to a target permission level may be determined, and a current coding unit is decoded based on the target region category, so that permission protection can be performed on various types of information (e.g., a license plate, a local region of a human body, a screen, text, etc.) of pictures and videos, thereby improving data security. For example, when a picture has an information security problem, permission protection may be performed on the picture, so that a user with a high permission level can view a large proportion or even all of picture information, and a user with a low permission level can only view a small proportion of picture information. For example, the picture may be divided into a low-permission region and a high-permission region, the user with a low permission can only view the low-permission region, and the user with a high permission can view the low-permission region and the high-permission region.

### BRIEF DESCRIPTION OF DRAWINGS

FIG. 1 is a schematic diagram of a video encoding framework.

FIG. 2A-FIG. 2C are schematic diagrams of a video coding framework.

FIG. 3 is a flowchart of a picture decoding method according to an implementation of the present disclosure.

FIG. 4 is a flowchart of a picture encoding method according to an implementation of the present disclosure.

FIG. 5 is a schematic diagram of a region corresponding to a region category identifier according to an implementation of the present disclosure.

FIG. 6 is a schematic diagram of a region corresponding to a region category identifier according to an implementation of the present disclosure.

FIG. 7 is a schematic diagram of a region corresponding to a region category identifier according to an implementation of the present disclosure.

FIG. 8 is a schematic diagram of a region corresponding to a region category identifier according to an implementation of the present disclosure.

FIG. 9A is a hardware structure diagram of a decoding device according to an implementation of the present disclosure.

FIG. 9B is a hardware structure diagram of an encoding device according to an implementation of the present disclosure.

### DETAILED DESCRIPTION

Terms used in embodiments of the present disclosure are merely intended to describe specific embodiments, but are not intended to limit the present disclosure. The singular forms “a”, “said”, and “the” used in the embodiments and claims of the present disclosure are also intended to include plural forms, unless otherwise specified in the context clearly. It will also be understood that the term “and/or” as used herein refers to any and all possible combinations of one or more of the associated listed items. It should be understood that although the embodiments of the present disclosure may use terms such as first and second to describe various information, the information should not be limited to these terms. These terms are only used to distinguish the same type of information from each other. For example, without departing from the scope of the embodiments of the present disclosure, first information may also be referred to as second information, and second information may also be referred to as first information, depending on a context. In addition, the term “if” may be construed as “when” or “upon” or “in response to determining”.

Embodiments of the present disclosure provide a picture decoding method and a picture encoding method, and may relate to the following concepts.

Prediction Pixel: a pixel value derived from already encoded/decoded pixels, and a residual is obtained based on a difference between an original pixel and the prediction pixel, so then, the residual is subjected to transform, quantization, and coefficient encoding. An inter prediction pixel refers to a pixel value derived from a reference frame (a reconstructed pixel frame) of a current block, and because pixel locations are discrete, a final prediction pixel needs to be acquired through an interpolation operation. The closer the prediction pixel is to the original pixel, the smaller the residual energy obtained by subtracting the two, and the higher the encoding compression performance.

Rate-Distortion Optimization (RDO): There are two indicators for evaluating encoding efficiency: a bit rate and a peak signal to noise ratio (PSNR), where a smaller bit stream indicates a larger compression ratio, and a larger PSNR indicates better quality of a reconstructed picture. For example, a cost corresponding to a mode is J(mode)=D+λ*R, where D represents distortion, and is usually measured by using a sum of the squired errors (SSE) indicator, SSE refers to a mean square sum of differences between a reconstructed picture block and a source picture. In order to achieve cost considerations, a sum of absolute values of differences (SAD) indicator may also be used, SAD is a sum of absolute values of differences between the reconstructed picture block and the source picture, λ is a Lagrange multiplier, and R is an actual quantity of bits required for encoding the picture block in the mode, including a sum of bits required for encoding mode information, motion information, a residual, etc. During mode selection, if a rate-distortion principle is used to make a comparison decision on an encoding mode, optimal encoding performance may usually be ensured.

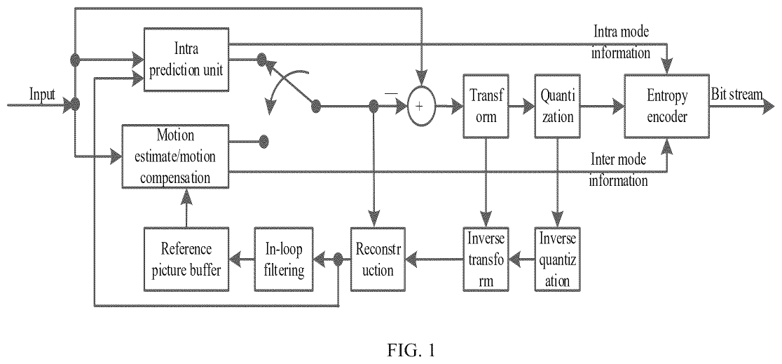

Video encoding framework: referring to FIG. 1, which is a schematic diagram of a video encoding framework of an encoder side, the video encoding framework may be used to implement an encoder side processing procedure of the present disclosure, and a schematic diagram of a video decoding framework may be similar to FIG. 1, and the video decoding framework may be used to implement a decoder side processing procedure of the present disclosure.

For example, referring to FIG. 1, the video encoding framework may include modules such as prediction, transform, quantization, entropy encoder, inverse quantization, inverse transform, reconstruction, and filtering. On the encoder side, a processing procedure of the encoder side may be implemented through cooperation between these modules. In addition, the video decoding framework may include modules such as prediction, transform, quantization, an entropy decoder, inverse quantization, inverse transform, reconstruction, and filtering, and on a decoder side, a processing procedure on the decoder side may be implemented through cooperation between these modules.

For each module of the encoder side, a large quantity of encoding tools are proposed, and each tool usually has a plurality of modes. For different video sequences, encoding tools that can obtain optimal encoding performance are often different. Therefore, in an encoding process, RDO is usually used to compare encoding performance of different tools or modes, so as to select an optimal mode. After the optimal tool or mode is determined, the decision information of the tool or mode is transmitted by encoding the flag information in the bit stream. Although this method brings high encoding complexity, an optimal mode combination may be adaptively selected for different contents to obtain optimal encoding performance. The decoder side obtains the related mode information by directly parsing the flag information, and the complexity is less affected.

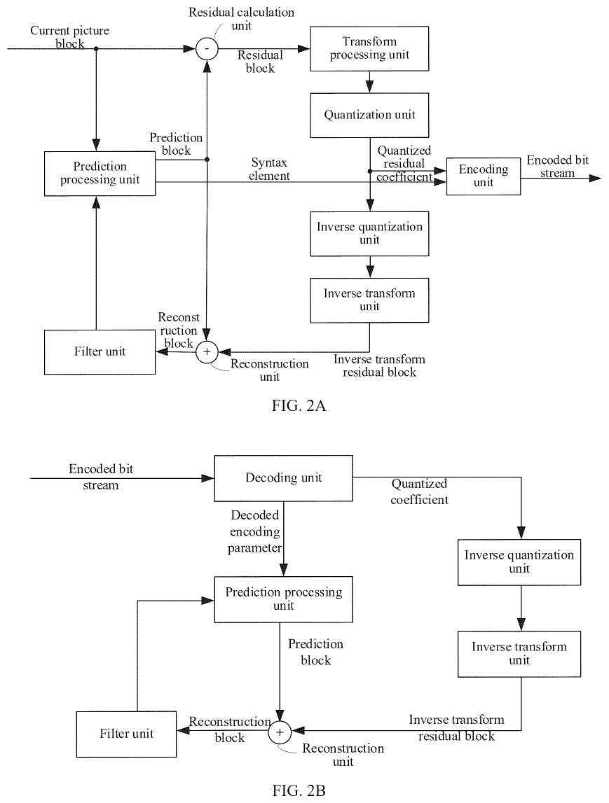

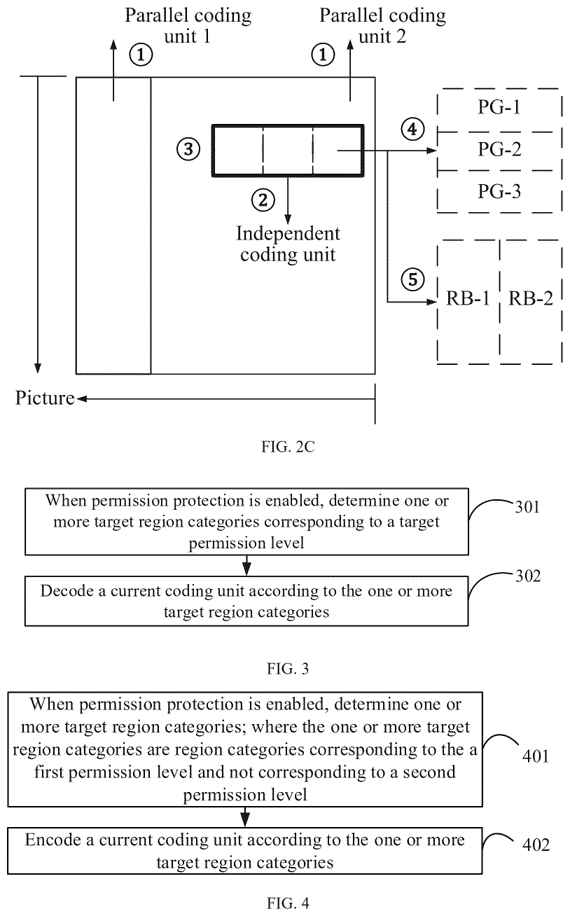

The structures of the encoder side and the decoder side are briefly described below. FIG. 2A shows a schematic block diagram of an example for implementing an encoder side. In FIG. 2A, the encoder side includes a prediction processing unit, a residual calculation unit, a transform processing unit, a quantization unit, an encoding unit, an inverse quantization unit (which may also be referred to as a reverse quantization unit), an inverse transform processing unit (which may also be referred to as a reverse transform processing unit), a reconstruction unit (or referred to as a rebuilding unit), and a filter unit. In an example, the encoder side may further include a buffer and a decoded picture buffer, where the buffer is configured to buffer the reconstructed coding units output by the reconstruction unit, and the decoded picture buffer is configured to buffer the filtered coding unit output by the filter unit.

An input of an encoder side (also referred to as an encoder) is a coding unit of a picture (which may be referred to as a to-be-encoded picture), the encoder side further includes a partitioning unit (not shown in the figure) configured to partition the to-be-encoded picture into a plurality of coding units. The encoder is configured to perform block-by-block encoding to complete encoding of the to-be-encoded picture, e.g., performing an encoding process on each coding unit. The prediction processing unit is configured to receive or acquire a coding unit (a current to-be-encoded coding unit of a current to-be-encoded picture) and reconstructed picture data, and predict a current block based on the relevant data in the reconstructed picture data, to obtain a prediction block of the current block. The prediction processing unit includes an inter prediction unit, an intra prediction unit, and a mode selection unit, where the mode selection unit is configured to select an intra prediction mode or an inter prediction mode; if the intra prediction mode is selected, a prediction process is performed by the intra prediction unit; and if the inter prediction mode is selected, a prediction process may be performed by the inter prediction unit.

The residual calculation unit is configured to calculate the residual between the true value of a coding unit and the prediction block of the coding unit. For example, the residual calculation unit may, pixel by pixel, subtract the pixel value of the prediction block from the pixel value of the coding unit. The transform processing unit is configured to perform transform such as discrete cosine transform (DCT) or discrete sine transform (DST) on the residual block, to acquire transform coefficients in a transform domain, where the transform coefficients may also be referred to as transform residual coefficients, which may represent the residual block in the transform domain. The quantization unit is configured to quantize the transform coefficients by applying scalar quantization or vector quantization, so as to obtain quantized transform coefficients. These quantized transform coefficients are also referred to as quantized residual coefficients. The quantization process may reduce a bit depth related to some or all of the transform coefficients. For example, an n-bit transform coefficient is rounded down to an m-bit transform coefficient during quantization, n being greater than m. The quantization degree is modified by adjusting the quantization parameter (QP). As for scalar quantization, different scales are applied to achieve finer or coarser quantization. A smaller quantization step corresponds to finer quantization, and a larger quantization step corresponds to coarser quantization. An appropriate quantization step is indicated through a quantization parameter (quantization parameter, QP).

The coding unit is configured to, encode the quantized residual coefficient, output encoded picture data in a form of an encoded bit stream (i.e., an encoding result of a current to-be-encoded coding unit), transmit the encoded bit stream to a decoder, or store the encoded bit stream, and subsequently transmit the encoded bit stream to the decoder or use it for retrieval. The coding unit may be further configured to encode another syntax element of the current coding unit, e.g., encode a prediction mode to a bit stream, etc. The coding algorithm includes, but is not limited to, a variable length coding (VLC) algorithm, a context adaptive VLC (CAVLC) algorithm, an arithmetic coding algorithm, a context adaptive binary arithmetic coding (CABAC) algorithm, a syntax-based context-adaptive binary arithmetic coding (SBAC) algorithm, and a probability interval partitioning entropy (PIPE) algorithm.

The inverse quantization unit is configured to perform inverse quantization on the quantized coefficients to acquire inverse-quantized coefficients, where the inverse quantization is a reverse application of the quantization unit, e.g., applying an inverse quantization scheme of a quantization scheme applied by the quantization unit based on or using the same quantization step size as the quantization unit. The inverse-quantized coefficients may also be referred to as inverse-quantized residual coefficients. The inverse transform processing unit is configured to perform inverse transform on the inverse-quantized coefficients, and it should be understood that the inverse transform is a reverse application of the transform processing unit, e.g., the inverse transform may include an inverse discrete cosine transform (DCT) or an inverse discrete sine transform (DST), to acquire an inverse transform block in a pixel domain (or referred to as a sample domain). The inverse transform block may also be referred to as an inverse transform inverse-quantized block or an inverse transform residual block. The reconstruction unit is configured to add an inverse transform block (i.e., an inverse transform residual block) to the prediction block to acquire a reconstructed block in a sample domain, and the reconstruction unit may be a summer, e.g., adding the sample values (i.e., pixel values) of the residual block to the sample values of the prediction block. The reconstructed block output by the reconstruction unit may be subsequently configured to predict other coding units, e.g., used in an intra prediction mode.

The filter unit (or “filter” for short) is configured to filter the reconstructed block to acquire a filtered block, to smooth pixel conversion or improve picture quality. The filter unit may be a loop filter unit intended to represent one or more loop filters, e.g., the filter unit may be a deblocking filter, a sample-adaptive offset (SAO) filter, or other filters such as a bilateral filter, an adaptive loop filter (ALF), a sharpening or smoothing filter, or a collaborative filter. In an example, the filtered block output by the filtering unit may be subsequently used to predict other coding units, e.g., used in an inter prediction mode, which is not limited.

FIG. 2B shows a schematic block diagram of an example of a decoder side (which may also be referred to as a decoder) configured to implement an embodiment of the present disclosure. The decoder is configured to receive, for example, encoded picture data (i.e., an encoded bit stream, e.g., an encoded bit stream including coding units and associated syntax elements) encoded by an encoder, to acquire a decoded picture. The decoder includes a decoding unit, an inverse quantization unit, an inverse transform processing unit, a prediction processing unit, a reconstruction unit, and a filter unit. In some examples, the decoder may perform decoding multiple times, wherein the decoding is inverse to the encoding operation depicted in the encoder of FIG. 2A, the number of the times for performing decoding is equal to the number of times for performing encoding. In an example, the encoder side may further include a buffer and a decoded picture buffer, where the buffer is configured to buffer the reconstructed coding units output by the reconstruction unit, and the decoded picture buffer is configured to buffer the filtered coding unit output by the filter unit.

The decoding unit is configured to decode the encoded picture data, to acquire quantized coefficients and/or decoded encoding parameters (e.g., the decoding parameters may include any or all of an inter prediction parameter, an intra prediction parameter, a filter parameter, and/or other syntax elements). The decoding unit is further configured to forward the decoded encoding parameters to the prediction processing unit, so that the prediction processing unit performs a prediction process according to the encoding parameters. The functionality of the inverse quantization unit may be the same as that of the inverse quantization unit of the encoder, which is configured to inverse quantize (i.e., reverse quantize) the quantized coefficients decoded by the decoding unit. The functionality of the inverse transform processing unit may be the same as that of the inverse transform processing unit in the encoder, and the functionality of the reconstruction unit (e.g., a summer) may be the same as that of the reconstruction unit in the encoder, which is configured to perform inverse transform (e.g., inverse DCT, inverse integer transform, or a conceptually similar inverse transform process) on the quantized coefficient, to obtain an inverse transform block (which may also be referred to as an inverse transform residual block), where the inverse transform block is a residual block of the current coding unit in the pixel domain.

The prediction processing unit is configured to receive or acquire encoded picture data (e.g., an encoded bit stream of a current coding unit) and reconstructed picture data, and the prediction processing unit may further receive or acquire prediction-related parameters and/or information about a selected prediction mode (i.e., decoded encoding parameters) from, e.g., a decoding unit, and predict the current coding unit based on related data in the reconstructed picture data and the decoded encoding parameters, to acquire a prediction block of the current coding unit. In an example, the prediction processing unit includes an inter prediction unit, an intra prediction unit, and a mode selection unit, where the mode selection unit is configured to select an intra prediction mode or an inter prediction mode; if the intra prediction mode is selected, a prediction process is performed by the intra prediction unit; and if the inter prediction mode is selected, a prediction process may be performed by the inter prediction unit.

The reconstruction unit is configured to add an inverse transform block (i.e., an inverse transform residual block) to the prediction block, e.g., adding the sample values of the inverse transform residual block to the sample values of the prediction block, to acquire a reconstructed block in a sample domain. The filter unit is configured to filter the reconstructed block to acquire a filtered block, where the filtered block is a decoded coding unit.

It should be understood that, in the encoder and the decoder, a processing result for a step may also be further processed and output to a next step, e.g., after a step such as interpolation filtering, motion vector derivation, or filtering, an operation such as clipping or shift is further performed on the processing result of the corresponding step.

Based on the encoder and the decoder, an embodiment of the present disclosure provides a possible encoding/decoding implementation, as shown in FIG. 2C, which is a flowchart of encoding and decoding according to an embodiment of the present disclosure, and the encoding and decoding implementation includes process \textcircled{1} to process \textcircled{5}, and process \textcircled{1} to process \textcircled{5} may be performed by the foregoing decoder and encoder. Process \textcircled{1}: a frame of picture is divided into one or more parallel coding units that do not overlap with each other. The one or more parallel coding units have no dependency relationship, and may be encoded and decoded completely in parallel/independently, e.g., the parallel coding unit 1 and the parallel coding unit 2 shown in FIG. 2C.

Process \textcircled{2}: each parallel coding unit may be subdivided into one or more independent coding units that do not overlap with each other, each of the independent coding units may be independent of each other, but may share some parallel coding unit header information. For example, the width of the independent coding unit is w_lcu, and the height is h_lcu. If a parallel coding unit is divided into one single independent coding unit, the size of the independent coding unit is exactly the same as that of the parallel coding unit; otherwise, the width of the independent coding unit should be greater than the height (except for an edge region). Generally, the independent coding unit may be a fixed w_lcu×h_lcu, where both w_lcu and h_lcu are 2 to the power of N (N≥0), e.g., a size of the independent coding unit being 128×4, 64×4, 32×4, 16×4, 8×4, 32×2, 16×2, or 8×2.

As a possible example, the independent coding unit may be a fixed 128×4. If the size of the parallel coding unit is 256×8, the parallel coding unit may be equally divided into 4 independent coding units; if the size of the parallel coding unit is 288×10, the parallel coding unit may be divided into: two independent coding units of 128×4 and one independent coding unit of 32×4 in a first/second row, and two independent coding units of 128×2 and one independent coding unit of 32×2 in a third row. It should be noted that, an independent coding unit may include three components of luminance Y, chrominance Cb, and chrominance Cr, or three components of red (R), green (G), and blue (B), or three components of luminance Y, chrominance Co, and chrominance Cg, or may include only one of these components. If the independent coding unit includes three components, the sizes of the three components may be completely the same or different, which are specifically related to the input format of a picture.

Process \textcircled{3}: For each independent coding unit, the independent coding unit may be subdivided into one or more non-overlapping coding units, and coding units within the independent coding unit may depend on each other, e.g., reference may be made to each other for a plurality of coding units when being encoded/decoded. If the size of the coding unit is the same as that of the independent coding unit (i.e., the independent coding unit is divided into only one coding unit), the size of the coding unit may be all the sizes described in the process \textcircled{2}. If the independent coding unit is divided into a plurality of coding units that do not overlap with each other, feasible division examples are: horizontal equal division (the height of the coding unit is the same as that of the independent coding unit, but the width is different, which may be ½, ¼, ⅛, 1/16, etc. of the width of the independent coding unit), vertical equal division (the width of the coding unit is the same as that of the independent coding unit, but the height is different, which may be ½, ¼, ⅛, 1/16, etc. of the height of the independent coding unit), and horizontal and vertical equal division (quadtree division), where horizontal equal division is preferred.

The width of the coding unit is w_cu, the height is h_cu, and the width should be greater than the height (except for an edge region). Generally, the coding unit is a fixed w_cu×h_cu, and both w_cu and h_cu are 2 to the power of N (N is greater than or equal to 0), e.g., 16×4, 8×4, 16×2, 8×2, 8×1, 4×1, etc. For example, the coding unit is a fixed 16×4. If the size of the independent coding unit is 64×4, the independent coding unit is equally divided into 4 coding units; if the size of the independent coding unit is 72×4, which is divided into 4 coding units of 16×4+1 coding unit of 8×4. It should be noted that, the coding unit may be three components: luminance Y, chrominance Cb, and chrominance Cr (or three components: red R, green G, and blue B, or, luminance Y, chrominance Co, and chrominance Cg), or may include only a certain component. If three components are included, the sizes of the components may be completely the same or different, which are related to the picture input format.

It should be noted that, the process \textcircled{3} may be an optional step in the encoding/decoding method, and the encoder/decoder may perform encoding and decoding on the residual coefficients (or residual values) of the independent coding unit obtained in the process \textcircled{2}.

Process \textcircled{4}: a coding unit may be subdivided into one or more non-overlapping prediction groups (PG), where the PG is also referred to as a group for short, each PG is encoded/decoded according to a selected prediction mode to obtain a prediction value of the PG, to form a prediction value of the entire coding unit, and a residual value of the coding unit is obtained based on the prediction value and the original value of the coding unit.

Process \textcircled{5}: the coding units are divided into groups based on residual values of the coding units, to obtain one or more non-overlapping residual blocks (RBs), and the residual coefficients of each RB are encoded/decoded according to a selected mode, to form a residual coefficient stream. Specifically, it may be divided into two categories: performing transform and not performing transform on the residual coefficients. The selected mode of the residual coefficient encoding/decoding method in process \textcircled{5} may include, but is not limited to, any one of the following: a semi-fixed-length encoding manner, an exponential-Golomb encoding method, a Golomb-Rice encoding method, a truncated unary code encoding method, a run-length encoding method, direct encoding of original residual values, etc. For example, the encoder directly encodes the coefficients within the RB. For another example, the encoder may perform transform on the residual block, e.g., DCT, DST, or Hadamard transform, and then encode transformed coefficients. As a possible example, when the RB is relatively small, the encoder directly performs unified quantization on each coefficient in the RB, and then performs binarization encoding. If the RB is relatively large, a plurality of coefficient groups (CGs) may be obtained through division, and then unified quantization is performed on each CG, and then binarization encoding is performed. In some embodiments of the present disclosure, the coefficient group (CG) and the quantization group (QG) may be the same, and certainly, the CG and the QG may be different.

An example illustration of the part of encoding the residual coefficients in a semi-fixed-length encoding manner is described below. First, the maximum absolute value of residuals within an RB block may be defined as the modified maximum (mm). Second, a quantity of coding bits for residual coefficients in the RB block (the quantity of coding bits for residual coefficients in the same RB block is consistent) is determined. For example, if a critical limit (CL) of the current RB block is 2, and the current residual coefficient is 1, encoding the residual coefficient 1 requires 2 bits, which is represented as 01. If the CL of the current RB block is 7, it means encoding an 8-bit residual coefficient and a 1-bit sign bit. The determination of CL is to find the minimum value M that satisfies the condition that all residuals of the current sub-block are within the range of [−2\hat{ }(M−1), 2\hat{ }(M−1)]. If there are two boundary values of −2\hat{ }(M−1) and 2\hat{ }(M−1) at the same time, M is increased by 1, i.e., M+1 bits are required to encode all residuals of the current RB block; if there is only one of the two boundary values of −2\hat{ }(M−1) and 2\hat{ }(M−1), a Trailing bit is encoded to determine whether the boundary value is −2\hat{ }(M−1) or 2\hat{ }(M−1); if there is not any one of −2\hat{ }(M−1) and 2\hat{ }(M−1) in all the residuals, there is no need to encode the Trailing bit. For some special cases, the encoder may directly encode the original values of the picture instead of encoding the residual values of the picture.

Certainly, the schematic flowchart of encoding and decoding shown in FIG. 2C is merely an example of an encoding and decoding implementation, i.e., the process \textcircled{1} to process \textcircled{5} is merely an example, which is not limited to this implementation. The picture decoding method and picture encoding method in this embodiment may be applied to any encoding and decoding implementation.

In a possible implementation, the decoder side may reconstruct a complete video picture, and the user may view the complete video picture. However, after the complete video picture is reconstructed, the complete video picture may present all permission information, e.g., license plate information, human body local region information, text information, screen information, etc., so there are security risks, and permission protection is needed.

In view of the above discovery, embodiments of the present disclosure provide a picture decoding method and a picture encoding method, which provide an encoding/decoding method for permission protection. In a public safety scenario, when a picture has an information security issue, permission protection may be performed on the picture, which may efficiently and losslessly express regions of the picture at each permission level, so that a user with a high permission level can view a large proportion or even all of picture information, and a user with a low permission level can only view a small proportion of picture information. For example, the picture may be divided into a low-permission region and a high-permission region, the user with a low-permission can only view the low-permission region, and the user with a high-permission can view the low-permission region and the high-permission region.

A picture decoding method and a picture encoding method are described in detail with reference to several specific embodiments below.

Embodiment 1: an embodiment of the present disclosure provides a picture decoding method, referring to FIG. 3, which is a schematic flowchart of the method, the method is applied to a decoding device (also referred to as a video decoder), and the method includes:

Step 301: when permission protection is enabled, determining one or more target region categories corresponding to a target permission level (the target permission level is a permission level of a user accessing the decoder side).

For example, if enable control information allows permission protection to be enabled, it is determined to enable the permission protection. For example, the enable control information may include, but is not limited to: enable control information at a sequence level or sequence level extension data; or enable control information at a picture level or picture level extension data; or enable control information at a slice level; or enable control information at a tile level; or enable control information at a patch level; or enable control information at a largest coding unit (LCU) level; or enable control information at a control unit level.

For example, if there is enable control information at multiple levels, the enable control information at a higher level is decoded; if the enable control information at the higher level does not allow permission protection to be enabled, it is determined not to enable the permission protection; if the enable control information at the higher level allows permission protection to be enabled, the enable control information at a lower level is decoded. If the enable control information at the lower level does not allow permission protection to be enabled, it is determined not to enable the permission protection; if the enable control information at the lower level allows permission protection to be enabled, and the enable control information at the lower level is the enable control information at the last level, it is determined to enable the permission protection; if the enable control information at the lower level allows permission protection to be enabled, and the enable control information at the lower level is not the enable control information at the last level, the enable control information at a further lower level is decoded, and so on.

For example, determining one or more target region categories corresponding to the target permission level may include, but is not limited to: querying a mapping relationship by using the target permission level and the candidate permission level, to obtain a region category corresponding to the target permission level and a region category corresponding to the candidate permission level, and determining the region category corresponding to the target permission level and the region category corresponding to the candidate permission level as the target region categories corresponding to the target permission level, where the candidate permission level is a permission level lower than the target permission level, and the mapping relationship includes a correspondence between permission levels and region categories.

For example, there is at least one region category (a default region category) that can be accessed by all permission levels, and regardless of which permission level the target permission level is, the target region categories corresponding to the target permission level includes the default region category, i.e., the default region category is used as a target region category of all permission levels. In this case, the correspondence between the permission level and the default region category does not need to be explicitly expressed.

Step 302: decoding the current coding unit according to the one or more target region categories.

For example, when the current coding unit is decoded, if a target region category exists in one or more current region categories corresponding to the current coding unit, the first bit stream corresponding to the current coding unit is decoded, where the first bit stream includes high-dimensional reconstruction information of the current coding unit; and the current coding unit is reconstructed based on the high-dimensional reconstruction information. Alternatively, if the target region category does not exist in the one or more current region categories corresponding to the current coding unit, the current coding unit is reconstructed based on low-dimensional reconstruction information.

For example, the low-dimensional reconstruction information is obtained by decoding the second bit stream corresponding to the current coding unit, the first bit stream is a bit stream obtained through decryption, and the second bit stream is a bit stream obtained without decryption.

In a possible implementation, one or more current region categories corresponding to the current coding unit may be further determined. For example, a region category identifier and multiple pieces of region location information corresponding to the region category identifier may be acquired; and for the current coding unit corresponding to the region location information, a region category corresponding to the region category identifier is determined as a current region category corresponding to the current coding unit.

For example, before acquiring one or more pieces of region location information corresponding to the region category identifier, the total quantity of picture regions corresponding to the region category identifier may be acquired; based on this, pieces of region location information as many as the total quantity of the picture regions corresponding to the region category identifier may be acquired, and the total quantity of picture regions is not greater than a preset quantity threshold.

For example, acquiring a region category identifier and region location information of one or more regions corresponding to the region category identifier may include, but is not limited to: decoding the region category identifier and the region location information of one or more regions corresponding to the region category identifier from the higher-level unit syntax of the current coding unit. Acquiring a total quantity of picture regions corresponding to the region category identifier may include, but is not limited to: decoding the total quantity of picture regions corresponding to the region category identifier from the higher-level unit syntax of the current coding unit.

For example, the region location information may include, but is not limited to, region location information of a polygonal region, a rectangular region, or a circular region. For example, for a polygonal region and a rectangular region, the region location information may include coordinates of at least one vertex relative to a preset origin; and for a circular region, the region location information may include center coordinates and a radius of the circular region relative to the preset origin.

For example, a plurality of picture units may be arranged in a preset scanning order, and the region location information may include a start picture unit index and an end picture unit index relative to a preset origin; or the region location information may include a start picture unit index relative to a preset origin and a total quantity of picture units in the current region; or the region location information may include an end picture unit index relative to a preset origin and a total quantity of picture units in the current region. For example, if the region category identifier corresponds to multiple pieces of region location information, an end picture unit of region location information of the previous region is determined as a preset origin corresponding to region location information of the current region.

For example, the picture unit may be a coding unit, or the picture unit may be an A*B picture unit obtained through division in a preset division manner, where A may be greater than or equal to a minimum size of the coding unit, e.g., 4, or 8, and B may be greater than or equal to the minimum size of the coding unit, e.g., 4, or 8.

For example, after the region category identifier is acquired, a combination identifier corresponding to the region category identifier may be further acquired, where the combination identifier indicates whether an associated region category identifier for a combination operation with the region category identifier exists; and if the combination identifier indicates that the associated region category identifier for the combination operation with the region category identifier exists, the associated region category identifier corresponding to the region category identifier may be acquired.

For example, after the associated region category identifier corresponding to the region category identifier is acquired, for the coding unit corresponding to the region location information corresponding to the associated region category identifier, the region category corresponding to the region category identifier and the region category corresponding to the associated region category identifier may be determined as the region categories corresponding to the coding unit, i.e., the coding unit may correspond to a plurality of region categories.

The permission level corresponding to the associated region category identifier is equal to the permission level corresponding to the region category identifier; or the permission level corresponding to the associated region category identifier is lower than the permission level corresponding to the region category identifier.

For example, before one or more associated region category identifiers corresponding to the region category identifier are acquired, a total quantity of category identifiers corresponding to the one or more associated region category identifiers may be acquired. Based on this, acquiring the one or more associated region category identifiers corresponding to the region category identifier includes, but is not limited to: acquiring the associated region category identifiers as many as the total quantity of category identifiers corresponding to the region category identifier, i.e., acquiring the associated region category identifiers as many as the total quantity of category identifiers.

For example, acquiring a combination identifier corresponding to the region category identifier may include, but is not limited to: decoding the combination identifier corresponding to the region category identifier from the higher-level unit syntax of the current coding unit; acquiring one or more associated region category identifiers corresponding to the region category identifier may include, but is not limited to: decoding the one or more associated region category identifiers corresponding to the region category identifier from the higher-level unit syntax of the current coding unit; and acquiring a total quantity of category identifiers corresponding to the one or more associated region category identifiers may include, but is not limited to: decoding the total quantity of category identifiers corresponding to the one or more associated region category identifiers from the higher-level unit syntax of the current coding unit.

In a possible implementation, one or more current region categories corresponding to the current coding unit may be further determined, for example, a region category identifier corresponding to each picture unit may be acquired; and based on the region category identifiers corresponding to the picture units covered by the current coding unit, a region category corresponding to the highest permission level in the region category identifiers may be determined as the current region category corresponding to the current coding unit.

For example, acquiring a region category identifier corresponding to each picture unit may include, but is not limited to, acquiring a region category identifier and region indication information, wherein the region indication information indicates a plurality of picture units, and determining the region category identifier as the region category identifier corresponding to the plurality of picture units.

The region indication information includes start point coordinates relative to a preset origin, at least one direction identifier, a length corresponding to each direction identifier, and an end flag; where the start point coordinates indicate a picture unit corresponding to a region category identifier, the direction identifier indicates a direction of picture units belonging to the same region category, a length corresponding to each direction identifier indicates a quantity of picture units in the direction of the picture units belonging to the same region category, and the end flag represents that indication of a plurality of picture units have been completed.

The length corresponding to each direction identifier may be fixed to 1.

For example, acquiring a region category identifier corresponding to each picture unit may further include: determining a target shape enclosed by the plurality of picture units indicated by the region indication information; and determining the region category identifier as a region category identifier corresponding to picture units within the target shape.

In the foregoing embodiment, the preset origin is an upper-left corner point of a preset M*N rectangle division, or the preset origin is obtained from decoding a bit stream. The preset M*N rectangular division is an LCU division.

For example, acquiring a region category identifier corresponding to each picture unit may include, but is not limited to, decoding the region category identifier corresponding to each picture unit from the higher-level unit syntax of the current coding unit.

In the foregoing embodiment, the higher-level unit may include, but is not limited to: an LCU, a patch, a slice, a tile, a picture, or a sequence, etc., in which the current coding unit is located, which is not limited.

For example, the foregoing execution sequence is merely an example for ease of description, and in actual application, an execution sequence between steps may be changed, and the execution sequence is not limited. Moreover, in other embodiments, the steps of the corresponding method are not necessarily performed in the order shown and described herein, and the method may include more or fewer steps than those described herein. In addition, a single step described in this specification may be divided into multiple steps for description in other embodiments; and multiple steps described in this specification may also be combined into a single step for description in other embodiments.

It can be seen from the foregoing technical solutions that, in the embodiments of the present disclosure, when permission protection is enabled, a target region category corresponding to a target permission level may be determined, and a current coding unit is decoded based on the target region category, so that permission protection can be performed on various types of permission information (e.g., license plate information, local human body region information, text information, screen information, etc.), thereby improving data security. For example, when an information security problem exists in a picture, permission protection may be performed on the picture, so that a user with a high permission level can view a large amount or even all of picture information, and a user with a low permission level can only view a small amount of picture information. For example, the picture may be divided into a low-permission region and a high-permission region, the low-permission user can only view the low-permission region, and the high-permission user can view the low-permission region and the high-permission region. Certainly, the permission may be further subdivided, different permissions correspond to different picture regions, while parallel permissions may also be set. For example, the license plate information can be viewed under permission A, the human body local region information can be viewed under permission B, and the license plate information and the human body local region information can be viewed under permission C.

Embodiment 2: An embodiment of the present disclosure provides a picture encoding method, referring to FIG. 4, which is a schematic flowchart of the method, the method is applied to an encoder side (also referred to as a video encoder), and the method includes the steps below.

Step 401: when permission protection is enabled, determining one or more target region categories; where the target region category is a region category corresponding to a first permission level and not corresponding to a second permission level, that is, at least one permission level corresponds to the target region category, and at least one permission level does not correspond to the target region category.

For example, if the enable control information allows permission protection to be enabled, it is determined that permission protection is enabled. For example, the enable control information may include, but is not limited to: enable control information at a sequence level or sequence level extension data; or enable control information at a picture level or picture level extension data; or enable control information at a slice level; or enable control information at a tile level; or enable control information at a patch level; or enable control information at an LCU level; or enable control information at a control unit level.

For example, if there is enable control information at multiple levels, the enable control information at a higher level is acquired; if the enable control information at the higher level does not allow permission protection to be enabled, it is determined to enable the permission protection; if the enable control information at the higher level allows permission protection to be enabled, the enable control information at a lower level is acquired. If the enable control information at the lower level does not allow permission protection to be enabled, it is determined not to enable the permission protection; if the enable control information at the lower level allows permission protection to be enabled, and the enable control information at the lower level is the enable control information at the last level, it is determined to enable the permission protection; if the enable control information at the lower level allows permission protection to be enabled, and the enable control information at the lower level is not the enable control information at the last level, the enable control information at a further lower level is acquired, and so on.

For example, determining one or more target region categories may include, but is not limited to: obtaining the target region category by querying a mapping relationship, where the mapping relationship includes a correspondence between permission levels and region categories. For example, if all permission levels correspond to a region category, the region category is not used as the target region category. If some permission levels correspond to a region category, but the remaining permission levels do not correspond to the region category, the region category is used as the target region category.

Step 402: encoding the current coding unit according to the one or more target region categories.

For example, when a current coding unit is encoded, if a target region category exists in one or more current region categories corresponding to the current coding unit, the first bit stream and the second bit stream corresponding to the current coding unit are encoded, where the first bit stream includes high-dimensional reconstruction information of the current coding unit, which is used to reconstruct the current coding unit, and the second bit stream includes low-dimensional reconstruction information of the current coding unit, which is used to reconstruct the current coding unit. Alternatively, when the current coding unit is encoded, if the target region category does not exist in the one or more current region categories corresponding to the current coding unit (i.e., the current region category is a region category corresponding to all permission levels, i.e., the current coding unit corresponding to the current region category can be viewed at all permission levels), the first bit stream corresponding to the current coding unit is encoded, where the first bit stream includes high-dimensional reconstruction information, and the high-dimensional reconstruction information is used to reconstruct the current coding unit.

For example, the second bit stream corresponding to the current coding unit is encoded, and the second bit stream includes low-dimensional reconstruction information. The first bit stream is an encrypted bit stream; and the second bit stream is an unencrypted bit stream.

In a possible implementation, one or more current region categories corresponding to the current coding unit may be further determined. For example, a region category identifier and region location information of one or more regions corresponding to the region category identifier may be acquired; and for the current coding unit corresponding to the region location information, a region category corresponding to the region category identifier is determined as a current region category corresponding to the current coding unit.

For example, before acquiring one or more pieces of region location information corresponding to the region category identifier, the total quantity of picture regions corresponding to the region category identifier may be acquired; and based on this, pieces of region location information as many as the total quantity of the picture regions corresponding to the region category identifier may be acquired, and the total quantity of picture regions is not greater than a preset quantity threshold.

For example, acquiring a region category identifier and region location information of one or more regions corresponding to the region category identifier may include, but is not limited to: acquiring the region category identifier and the region location information of one or more regions corresponding to the region category identifier, and encoding the region category identifier and the region location information of one or more regions corresponding to the region category identifier in the higher-level unit syntax of a current coding unit.

For example, acquiring a total quantity of picture regions corresponding to the region category identifier may include, but is not limited to: acquiring the total quantity of picture regions corresponding to the region category identifier, and encoding, in the higher-level unit syntax of the current coding unit, the total quantity of picture regions corresponding to the region category identifier.

For example, the region location information may include, but is not limited to, region location information of a polygonal region, a rectangular region, or a circular region. For example, for a polygonal region and a rectangular region, the region location information may include coordinates of at least one vertex relative to a preset origin; and for a circular region, the region location information may include center coordinates and a radius of the circular region relative to the preset origin.

For example, a plurality of picture units may be arranged in a preset scanning order, and the region location information may include a start picture unit index and an end picture unit index relative to a preset origin; or the region location information may include a start picture unit index relative to a preset origin and a total quantity of picture units in the current region; or the region location information may include an end picture unit index relative to a preset origin and a total quantity of picture units in the current region. For example, if the region category identifier corresponds to multiple pieces of region location information, using an end picture unit of region location information of a previous region as a preset origin corresponding to region location information of a current region.

For example, the picture unit may be a coding unit, or the picture unit may be an A*B picture unit obtained through division in a preset division manner, where A may be greater than or equal to a minimum size of the coding unit, e.g., 4, or 8, and B may be greater than or equal to the minimum size of the coding unit, e.g., 4, or 8.

For example, after the region category identifier is acquired, a combination identifier corresponding to the region category identifier may be further acquired, where the combination identifier indicates whether an associated region category identifier for a combination operation with the region category identifier exists; and if the combination identifier indicates that the associated region category identifier for the combination operation with the region category identifier exists, the associated region category identifier corresponding to the region category identifier may be acquired.

For example, after the associated region category identifier corresponding to the region category identifier is acquired, for the coding unit corresponding to the region location information corresponding to the associated region category identifier, the region category corresponding to the region category identifier and the region category corresponding to the associated region category identifier may be determined as the region categories corresponding to the coding unit, i.e., the coding unit may correspond to a plurality of region categories.

The permission level corresponding to the associated region category identifier is equal to the permission level corresponding to the region category identifier; or the permission level corresponding to the associated region category identifier is lower than the permission level corresponding to the region category identifier.

For example, before one or more associated region category identifiers corresponding to the region category identifier are acquired, a total quantity of category identifiers corresponding to the one or more associated region category identifiers may be acquired. Based on this, acquiring the one or more associated region category identifiers corresponding to the region category identifier includes, but is not limited to: acquiring the associated region category identifiers corresponding to the region category identifier as many as the total quantity of category identifiers, i.e., acquiring the associated region category identifiers as many as the total quantity of category identifiers.

For example, acquiring a combination identifier corresponding to the region category identifier may include, but is not limited to: acquiring the combination identifier corresponding to the region category identifier, and in the higher-level unit syntax of the current coding unit, encoding the combination identifier corresponding to the region category identifier; acquiring one or more associated region category identifiers corresponding to the region category identifier may include, but is not limited to: acquiring the one or more associated region category identifiers corresponding to the region category identifier, and in the higher-level unit syntax of the current coding unit, encoding the one or more associated region category identifiers corresponding to the region category identifier; and acquiring a total quantity of category identifiers corresponding to the one or more associated region category identifiers may include, but is not limited to: acquiring the total quantity of category identifiers corresponding to the one or more associated region category identifiers, and in the higher-level unit syntax of the current coding unit, encoding the total quantity of category identifiers corresponding to the one or more associated region category identifiers.

In a possible implementation, one or more current region categories corresponding to the current coding unit may be further determined, for example, a region category identifier corresponding to each picture unit may be acquired; and based on the region category identifiers corresponding to the picture units covered by the current coding unit, a region category corresponding to the highest permission level in the region category identifiers may be determined as the current region category corresponding to the current coding unit.

For example, acquiring a region category identifier corresponding to each picture unit may include, but is not limited to, acquiring the region category identifier and region indication information, wherein the region indication information indicates a plurality of picture units, and determining the region category identifiers as region category identifiers corresponding to the plurality of picture units.

The region indication information includes start point coordinates relative to a preset origin, at least one direction identifier, a length corresponding to each direction identifier, and an end flag; where the start point coordinates indicate a picture unit corresponding to a region category identifier, the direction identifier indicates a direction of picture units belonging to the same region category, a length corresponding to each direction identifier indicates a quantity of picture units in the direction of the picture units belonging to the same region category, and the end flag indicates that a plurality of picture units have been completed.

The length corresponding to each direction identifier may be fixed to 1.

For example, acquiring a region category identifier corresponding to each picture unit may further include: determining a target shape enclosed by the plurality of picture units indicated by the region indication information; and determining the region category identifier as a region category identifier corresponding to picture units within the target shape.

In the foregoing embodiment, the preset origin is an upper-left corner point of a preset M*N rectangle division, or the preset origin is obtained from decoding a bit stream. The preset M*N rectangular division is an LCU division.

For example, acquiring a region category identifier corresponding to each picture unit may include, but is not limited to: acquiring the region category identifier corresponding to each picture unit, and in the higher-level unit syntax of the current coding unit, encoding the region category identifier corresponding to each picture unit.

In the foregoing embodiment, the higher-level unit may include, but is not limited to, an LCU, a patch, a slice, a tile, a picture, or a sequence, etc., in which the current coding unit is located, which is not limited.

For example, the foregoing execution sequence is merely an example for ease of description, and in actual application, an execution sequence between steps may be changed, and the execution sequence is not limited. Moreover, in other embodiments, the steps of the corresponding method are not necessarily performed in the order shown and described herein, and the method may include more or fewer steps than those described herein. In addition, a single step described in this specification may be divided into multiple steps for description in other embodiments; and multiple steps described in this specification may also be combined into a single step for description in other embodiments.

As can be seen from the above technical solutions, in the embodiments of the present disclosure, when permission protection is enabled, the target region category may be determined, and the current coding unit is encoded according to the one or more target region categories, so that permission protection can be performed on various types of permission information (e.g., license plate information, local human body region information, text information, screen information, etc.), thereby improving data security. For example, when an information security problem exists in a picture, permission protection may be performed on the picture, so that a user with a high permission level can view a large amount or even all of picture information, and a user with a low permission level can only view a small amount of picture information. For example, the picture may be divided into a low-permission region and a high-permission region, the low-permission user can only view the low-permission region, and the high-permission user can view the low-permission region and the high-permission region. Certainly, the permission may be further subdivided, different permissions correspond to different picture regions, while parallel permissions may also be set. For example, the license plate information can be viewed under permission A, the human body local region information can be viewed under permission B, and screen information can be viewed under permission C.

Embodiment 3: for Embodiment 1 and Embodiment 2, when permission protection is enabled, the decoder side may determine the target permission level. For example, assuming that the user A currently views the picture reconstructed by the decoder side, the permission level of the user A is used as the target permission level; or assuming that the user B currently views the picture reconstructed by the decoder side, the permission level of the user B is used as the target permission level, and so on. After obtaining the target permission level, the decoder side may determine one or more target region categories corresponding to the target permission level, i.e., the target permission level may correspond to one target region category, and the target permission level may also correspond to a plurality of target region categories, specific determination processes can be referred from the subsequent embodiments. When permission protection is enabled, the encoder side may determine one or more target region categories, where the target region category is a region category corresponding to the first permission level and not corresponding to the second permission level, that is, at least one permission level corresponds to the target region category, and at least one permission level does not correspond to the target region category, specific determination processes can be referred from the subsequent embodiments.

After obtaining the target region category, the encoder side may encode the current coding unit according to the one or more target region categories, and the decoder side may decode the current coding unit according to the one or more target region categories.

For example, for an encoder side, when encoding a current coding unit (i.e., a current block, each to-be-encoded block in a current picture may be referred to as a current coding unit), a current region category corresponding to the current coding unit (the region category corresponding to the current coding unit may be recorded as a current region category) may be determined, and the current coding unit may correspond to one current region category, or may correspond to a plurality of current region categories. How to determine a current region category corresponding to the current coding unit may be referred from the subsequent embodiments. When decoding a current coding unit (i.e., a current block, each to-be-encoded block in a current picture may be referred to as a current coding unit), a decoder side may determine a current region category corresponding to the current coding unit, where the current coding unit may correspond to one current region category, or may correspond to a plurality of current region categories.

After a current region categories corresponding to the current coding unit is obtained, if the target region category exists in the one or more current region categories corresponding to the current coding unit, the encoder side may further encode the first bit stream and the second bit stream corresponding to the current coding unit, where the first bit stream includes high-dimensional reconstruction information of the current coding unit, the high-dimensional reconstruction information is used to reconstruct the current coding unit, the second bit stream includes low-dimensional reconstruction information of the current coding unit, and the low-dimensional reconstruction information is used to reconstruct the current coding unit.

After a current region category corresponding to the current coding unit is obtained, if the target region category (which may be different from the target region category of the encoding end) exists in the one or more current region categories corresponding to the current coding unit, the decoder side may decode the first bit stream corresponding to the current coding unit, parse out the high-dimensional reconstruction information of the current coding unit from the first bit stream, and reconstruct the current coding unit based on the high-dimensional reconstruction information. Alternatively, if the target region category does not exist in the one or more current region categories corresponding to the current coding unit, the decoder side may decode the second bit stream corresponding to the current coding unit, parse out low-dimensional reconstruction information of the current coding unit from the second bit stream, and reconstruct the current coding unit based on the low-dimensional reconstruction information.

For example, the high-dimensional reconstruction information may also be referred to as open reconstruction information, the high-dimensional reconstruction information includes reconstruction values of all pixels, the reconstruction values of the pixels are not hidden for the high-dimensional reconstruction information, and picture content can be completely restored by using the high-dimensional reconstruction information. For example, for a current coding unit of regions such as a local region of a human body, a license plate, a screen, and text, if the current coding unit is reconstructed based on high-dimensional reconstruction information, a real picture of regions such as the local region of the human body, the license plate, the screen, and the text may be viewed, and the real picture of regions such as the local region of the human body, the license plate, the screen, and the text is not hidden.

For example, the low-dimensional reconstruction information may also be referred to as hidden reconstruction information, and the low-dimensional reconstruction information does not include reconstruction values of every pixel, and may include only reconstruction values of some pixels (a decoder only parses the reconstruction values of these pixels, and a default value may be used for remaining pixels), or may include only one pixel value (i.e., all pixels share the pixel value, e.g., 255 or 0), or may include several pixel values (e.g., an average value of some pixels, e.g., 137 or 245), i.e., the reconstruction values of the pixels in the low-dimensional reconstruction information are hidden, and picture content cannot be completely restored by using the low-dimensional reconstruction information. For example, for a current coding unit of a human body local region, a license plate, a screen, a text and other regions, if the current coding unit is reconstructed based on low-dimensional reconstruction information, a real picture of regions such as the human body local region, the license plate, the screen, and the text cannot be viewed, i.e., the real picture of regions such as the human body local region, the license plate, the screen, and the text is hidden.

After the current region category corresponding to the current coding unit is obtained, if the target region category does not exist in the one or more current region categories corresponding to the current coding unit (i.e., the current region category is a region category corresponding to all permission levels, i.e., the current coding unit corresponding to the current region category can be viewed at all permission levels), the encoder may encode the first bit stream corresponding to the current coding unit, where the first bit stream includes high-dimensional reconstruction information of the current coding unit, and the high-dimensional reconstruction information is used to reconstruct the current coding unit.

After the decoder side obtains a current region category corresponding to the current coding unit, if the target region category exists in the one or more current region categories corresponding to the current coding unit, the decoder side may further decode the first bit stream corresponding to the current coding unit, parse out the high-dimensional reconstruction information of the current coding unit from the first bit stream, and reconstruct the current coding unit based on the high-dimensional reconstruction information.

For example, for the encoder side, when encoding the current coding unit, it may be determined whether the target region category exists in the current region categories corresponding to the current coding unit. If so, the first bit stream corresponding to the current coding unit is encoded, where the first bit stream includes the high-dimensional reconstruction information of the current coding unit, but no low-dimensional reconstruction information of the current coding unit is encoded (i.e., the low-dimensional reconstruction information is not carried in the second bit stream). When decoding a current coding unit, a decoder side may: determine current region categories corresponding to the current coding unit, and if a target region category exists in the current region categories corresponding to the current coding unit, decode the first bit stream corresponding to the current coding unit, parse out high-dimensional reconstruction information of the current coding unit from the first bit stream, and reconstruct the current coding unit based on the high-dimensional reconstruction information. If the target region category does not exist in the current region categories corresponding to the current coding unit, low-dimensional reconstruction information is directly derived (not parsed from the second bit stream), and the current coding unit is reconstructed based on the low-dimensional reconstruction information.

When the target region category does not exist in the current region categories corresponding to the current coding unit, the decoder side does not decode the low-dimensional reconstruction information from the bit stream, but derives the low-dimensional reconstruction information, e.g., deriving the low-dimensional reconstruction information based on reconstruction data, or the low-dimensional reconstruction information is default information, which is not limited.

In the foregoing embodiment, for the encoder side, the first bit stream is an encrypted bit stream, i.e., when the first bit stream corresponding to the current coding unit is encoded, the first bit stream may be encrypted, to perform encryption protection on the first bit stream. The second bit stream is an unencrypted bit stream, i.e., the second bit stream is not encrypted when the second bit stream corresponding to the current coding unit is encoded. Certainly, the encoder side may also encrypt the second bit stream.

For the decoder side, the first bit stream is a bit stream obtained through decryption, i.e., when the first bit stream corresponding to the current coding unit is decoded, the first bit stream may be decrypted to obtain a decrypted first bit stream. The second bit stream is an unencrypted bit stream, i.e., when the second bit stream corresponding to the current coding unit is decoded, the second bit stream is not decrypted, and the decoder side may directly obtain the unencrypted second bit stream.

In the foregoing embodiment, the first bit stream and the second bit stream are not necessarily consecutive bit streams, and may be obtained from a specific location in an overall bit stream, for example, the first bit streams of all coding units are spliced together, and second bit streams of all coding units are spliced together. Certainly, the first bit stream and the second bit stream of each coding unit may alternatively be consecutive bit streams, i.e., the first bit stream and the second bit stream of a coding unit are spliced together.

The first bit stream and the second bit stream may be a single bit stream instead of two separate bit streams. For example, the first bit stream and the second bit stream may correspond to a same sequence header and correspond to a same picture header.

For example, for an encoder, when a current coding unit is encoded, a current region category corresponding to the current coding unit may be determined, and if the current region category corresponding to the current coding unit is a default region category (indicating that permission protection does not need to be performed on a region in which the current coding unit is located, and high-dimensional reconstruction information and low-dimensional reconstruction information do not need to be distinguished), a bit stream corresponding to the current coding unit is encoded, which includes reconstruction information of the current coding unit (the high-dimensional reconstruction information and the low-dimensional reconstruction information do not need to be distinguished, and reconstruction information of the current coding unit is carried). When decoding a current coding unit, a decoder side may: determine a current region category corresponding to the current coding unit, and if the current region category corresponding to the current coding unit is a default region category, decode a bit stream corresponding to the current coding unit, parse out reconstruction information of the current coding unit from the bit stream, and reconstruct the current coding unit based on the reconstruction information.

Embodiment 4: Embodiment 4 is used to implement hierarchical control. In Embodiment 1, Embodiment 2, and Embodiment 3, for an encoder side and a decoder side, when permission protection is enabled, a target region category needs to be determined, and a current coding unit is encoded or decoded based on the target region category. As to whether permission protection is enabled (which may also be referred to as information protection), flag bit transfer may be performed at a sequence level, sequence level extension data, a picture level, a picture level extension data, a slice level, a tile level, a patch level, an LCU level, or a control unit level etc., and the flag bit indicates whether permission protection is enabled. If the flag bit is the first value, permission protection is allowed to be enabled; or if the flag bit is the second value, permission protection is not allowed to be enabled. A syntax used to manage or control several pictures may be referred to as a sequence-level or sequence-level extension data, a syntax used to manage or control a single-frame picture may be referred to as a picture-level or picture-level extension data; a syntax used to manage or control a parallel unit (i.e., a picture region) including several coding units may be referred to as a slice level, a tile level, or a patch level; a syntax used to manage or control the largest coding unit may be referred to as an LCU level; and a syntax used to manage or control a control unit may be referred to as a control unit level. A control unit may include a plurality of largest coding units, or a largest coding unit may include a plurality of control units, which is not limited.

For example, if the enable control information allows permission protection to be enabled, it is determined that permission protection is enabled. If the enable control information does not allow permission protection to be enabled, it is determined that enabling permission protection is prohibited.

For example, the enable control information may include, but is not limited to: enable control information at a sequence level or sequence level extension data; or enable control information at a picture level or picture level extension data; or enable control information at a slice level; or enable control information at a tile level; or enable control information at a patch level; or enable control information at an LCU level; or enable control information at a control unit level.

For example, if the enable control information at a sequence level allows permission protection to be enabled, it is determined to enable the permission protection. If the enable control information at a sequence level does not allow permission protection to be enabled, it is determined that enabling permission protection is prohibited. The enable control information at a sequence level may include a sequence-level flag bit, if the sequence-level flag bit is the first value, permission protection is allowed to be enabled, and if the sequence-level flag bit is the second value, permission protection is not allowed to be enabled.

For another example, if the enable control information at sequence level extension data allows permission protection to be enabled, it is determined to enable the permission protection. If the enable control information at sequence level extension data does not allow permission protection to be enabled, it is determined that enabling permission protection is prohibited. The enable control information at sequence level extension data may include a sequence-level extension data flag bit, if the sequence-level extension data flag bit is the first value, permission protection is allowed to be enabled, and if the sequence-level extension data flag bit is the second value, permission protection is not allowed to be enabled.

For another example, if the enable control information at the picture level allows permission protection to be enabled, it is determined to enable the permission protection. If the enable control information at the picture level does not allow permission protection to be enabled, it is determined that enabling permission protection is prohibited. The enable control information at the picture level may include a picture-level flag bit, if the picture-level flag bit is the first value, permission protection is allowed to be enabled, and if the picture-level flag bit is the second value, permission protection is not allowed to be enabled.

For another example, if the enable control information at picture level extension data allows permission protection to be enabled, it is determined to enable the permission protection. If the enable control information at picture level extension data does not allow permission protection to be enabled, it is determined that enabling permission protection is prohibited. The enable control information at picture level extension data may include a picture-level extension data flag bit, if the picture-level extension data flag bit is the first value, permission protection is allowed to be enabled, and if the picture-level extension data flag bit is the second value, permission protection is not allowed to be enabled.

For another example, if the enable control information at the slice level allows permission protection to be enabled, it is determined to enable the permission protection. If the enable control information at the slice level does not allow permission protection to be enabled, it is determined that enabling permission protection is prohibited. The enable control information at the slice level may include a slice-level flag bit, if the slice-level flag bit is the first value, permission protection is allowed to be enabled, and if the slice-level flag bit is the second value, permission protection is not allowed to be enabled.

For another example, if the enable control information at a tile level allows permission protection to be enabled, it is determined to enable the permission protection. If the enable control information at a tile level does not allow permission protection to be enabled, it is determined that enabling permission protection is prohibited. The enable control information at a tile level may include a tile-level flag bit, and if the tile-level flag bit is the first value, permission protection is allowed to be enabled, and if the tile-level flag bit is the second value, permission protection is not allowed to be enabled.

For another example, if the enable control information at the patch level allows permission protection to be enabled, it is determined to enable the permission protection. If the enable control information at a patch level does not allow permission protection to be enabled, it is determined that enabling permission protection is prohibited. The enable control information at a patch level may include a patch-level flag bit, if the patch-level flag bit is the first value, permission protection is allowed to be enabled, and if the patch-level flag bit is the second value, permission protection is not allowed to be enabled.

For another example, if the enable control information at the LCU level allows permission protection to be enabled, it is determined to enable the permission protection. If the enable control information at the LCU level does not allow permission protection to be enabled, it is determined that enabling permission protection is prohibited. The enable control information at the LCU level may include an LCU-level flag bit, if the LCU-level flag bit is the first value, permission protection is allowed to be enabled, and if the LCU-level flag bit is the second value, permission protection is not allowed to be enabled.

For another example, if the enable control information at a control unit level allows permission protection to be enabled, it is determined to enable the permission protection. If the enable control information at a control unit level does not allow permission protection to be enabled, it is determined that enabling permission protection is prohibited. The control unit level enable control information may include a control unit level flag bit, if the control unit level flag bit is the first value, permission protection is allowed to be enabled, and if the control unit level flag bit is the second value, permission protection is not allowed to be enabled. Certainly, the foregoing descriptions are merely examples, which are not limited.

For example, the enable control information at a sequence level/sequence level extension data can allow permission protection to be enabled for the current sequence, i.e., permission protection is enabled for all coding units in the current sequence. The enable control information at picture level/picture level extension data can allow permission protection to be enabled for the current picture, i.e., permission protection is enabled for all coding units in the current picture. The enable control information at a slice level can allow permission protection to be enabled for the current slice, i.e., permission protection is enabled for all coding units in the current slice. The enable control information at a tile level can allow permission protection to be enabled for the current tile, i.e., permission protection is enabled for all coding units in the current tile. The enable control information at a patch level can allow permission protection to be enabled for the current patch, i.e., permission protection is enabled for all coding units in the current patch. The enable control information at an LCU level can allow permission protection to be enabled for the current LCU, i.e., permission protection is enabled for all coding units in the current LCU. The enable control information at the control unit level can allow permission protection to be enabled for the current control unit, i.e., permission protection is enabled for all coding units in the current control unit.

Embodiment 5: Embodiment 5 is used to implement hierarchical control. In Embodiment 1, Embodiment 2, and Embodiment 3, for whether permission protection is enabled, if multi-level control exists, the principle that the lower level is controlled by the higher level is followed. For the encoder side, if the enable control information at multiple levels exists, the enable control information at a higher level is acquired; if the enable control information at the higher level does not allow permission protection to be enabled, it is determined not to enable the permission protection; if the enable control information at the higher level allows permission protection to be enabled, the enable control information at a lower level is acquired. If the enable control information at the lower level does not allow permission protection to be enabled, it is determined not to enable the permission protection; if the enable control information at the lower level allows permission protection to be enabled, and the enable control information at the lower level is the enable control information at the last level, it is determined that the permission protection is enabled; if the enable control information at the lower level allows permission protection to be enabled, and the enable control information at the lower level is not the enable control information at the last level, the enable control information at a further lower level is acquired, and so on. For the decoder side, if the enable control information at multiple levels exists, the enable control information at a higher level is decoded; if the enable control information at the higher level does not allow permission protection to be enabled, it is determined not to enable the permission protection; if the enable control information at the higher level allows permission protection to be enabled, the enable control information at a lower level is decoded. If the enable control information at the lower level does not allow permission protection to be enabled, it is determined not to enable the permission protection; if the enable control information at the lower level allows permission protection to be enabled, and the enable control information at the lower level is the enable control information at the last level, it is determined that the permission protection is enabled; if the enable control information at the lower level allows permission protection to be enabled, and the enable control information at the lower level is not the enable control information at the last level, the enable control information at the lower level is decoded, and so on.

The multi-level enable control information being two-level enable control information is taken as an example, the enable control information at the higher level is recorded as the first enable control information, and the enable control information at the lower level is recorded as the second enable control information. The processing process of the decoder side is taken as an example, the first-level enable control information is decoded first; if the first-level enable control information does not allow permission protection to be enabled, it is determined not to enable the permission protection; and if the first-level enable control information allows permission protection to be enabled, the second-level enable control information is decoded. If the second-level enable control information does not allow permission protection to be enabled, it is determined not to enable the permission protection; if the second-level enable control information allows permission protection to be enabled, it is determined to enable the permission protection. For example, the first enable control information may be enable control information at a sequence level/sequence level extension data, and the second enable control information may be enable control information at a picture level/picture level extension data, enable control information at a slice level, enable control information at a tile level, enable control information at a patch level, enable control information at an LCU level, or enable control information at a control unit level. For another example, the first enable control information may be enable control information at a picture level/picture level extension data, and the second enable control information may be enable control information at a slice level, enable control information at a tile level, enable control information at a patch level, enable control information at an LCU level, or enable control information at a control unit level.

For example, if identifier A exists at a sequence level and identifier B exists at a slice level, then identifier B explicitly exists in the bit stream only when permission protection is enabled (i.e., permission protection is allowed) for identifier A.

The multiple levels of enable control information being three levels of enable control information is taken as an example, the enable control information at the higher level may be recorded as the first enable control information, the enable control information at the middle level may be recorded as the second enable control information, and the enable control information at the lower level may be recorded as the third enable control information. The processing process of the decoder side is taken as an example, the first-level enable control information may be decoded first; if the first-level enable control information does not allow permission protection to be enabled, it is determined not to enable the permission protection; if the first-level enable control information allows permission protection to be enabled, the second-level enable control information is decoded; if the second-level enable control information does not allow permission protection to be enabled, it is determined not to enable the permission protection; if the second-level enable control information allows permission protection to be enabled, the third-level enable control information is decoded; if the third-level enable control information does not allow permission protection to be enabled, it is determined not to enable the permission protection; and if the third-level enable control information allows permission protection to be enabled, it is determined to enable the permission protection. For example, the first enable control information may be enable control information at a sequence level/sequence level extension data, and the second enable control information may be enable control information at a picture level/picture level extension data, enable control information at a slice level, enable control information at a tile level, enable control information at a patch level, enable control information at an LCU level, or enable control information at a control unit level.

For other cases such as four levels of enable control information, the implementation is similar, which is not described herein again.

Embodiment 6: Embodiment 6 is used to implement region inheritance in region depiction, and in Embodiment 1, Embodiment 2, and Embodiment 3, the decoder needs to determine one or more target region categories corresponding to the target permission level, and in order to determine the target region categories corresponding to the target permission level, the following method may be used: querying a mapping relationship through the target permission level and a candidate permission level, to obtain a region category corresponding to the target permission level and a region category corresponding to the candidate permission level, and determining the region category corresponding to the target permission level and the region category corresponding to the candidate permission level as one or more target region categories corresponding to the target permission level; where the candidate permission level is a permission level lower than the target permission level. For example, a mapping relationship may be preconfigured, and the mapping relationship may include a correspondence between permission levels and region categories, so that permission levels can be divided for each region category.

For example, the permission levels and the region categories may be in one-to-one correspondence, which is equivalent to that each coding unit corresponds to one permission level, as shown in Table 1, which is an example of the mapping relationship. The permission levels and the region categories may be in a one-to-many relationship, and different permission levels may correspond to the same number of region categories, referring to Table 2, which is an example of the mapping relationship. Different permission levels may also correspond to different numbers of region categories, referring to Table 3, which is an example of the mapping relationship. The permission levels and the region categories may be in a many-to-one relationship, i.e., a plurality of permission levels may correspond to the same region category, referring to Table 4, which is an example of the mapping relationship.

TABLE 1

| permission levels | region categories |
|---|---|
| permission level 1 | region category 1 |
| permission level 2 | region category 2 |
| permission level 3 | region category 3 |

TABLE 2

| permission levels | region categories |
|---|---|
| permission level 1 | region category 1, region category 2 |
| permission level 2 | region category 3, region category 4 |
| permission level 3 | region category 5, region category 6 |

TABLE 3

| permission levels | region categories |
|---|---|
| permission level 1 | region category 1 |
| permission level 2 | region category 2, region category 3, region category 4 |
| permission level 3 | region category 5, region category 6 |

TABLE 4

| permission levels | region categories |
|---|---|
| permission level 1, permission level 2 | region category 1 |
| permission level 3, permission level 4 | region category 2 |
| permission level 5 | region category 3 |

The mapping relationship shown in Table 1 is taken as an example, If the permission levels from high to low in sequence are: permission level 1>permission level 2>permission level 3, permission level 1 may access region category 1, region category 2, and region category 3; permission level 2 may access region category 2 and region category 3; and permission level 3 may access region category 3. If the permission levels from high to low in sequence are: permission level 1=permission level 2>permission level 3, permission level 1 may access region category 1 and region category 3; permission level 2 may access region category 2 and region category 3; and permission level 3 may access region category 3. If the permission levels from high to low in sequence are: permission level 1>permission level 2=permission level 3, permission level 1 may access region category 1, region category 2, and region category 3; permission level 2 may access region category 2; and permission level 3 may access region category 3, that is, a higher-level permission level may access the region categories of a lower-level permission level.

The mapping relationship shown in Table 2 is taken as an example, the six region categories are divided into three permission levels, where region category 1 and region category 2 are assigned to permission level 1, region category 3 and region category 4 are assigned to permission level 2, and region category 5 and region category 6 are assigned to permission level 3. If an order of the permission levels from high to low is: permission level 1>permission level 2>permission level 3, permission level 1 may access region category 1, region category 2, region category 3, region category 4, region category 5, and region category 6; permission level 2 may access region category 3, region category 4, region category 5, and region category 6; and permission level 3 may access region category 5 and region category 6, i.e., a higher-level permission level may access the region categories of a lower-level permission level.

In summary, when the target region category corresponding to the target permission level is determined, the mapping relationship may be queried through the target permission levels and the candidate permission levels, to obtain the region categories corresponding to the target permission level and the candidate permission level, and the region categories corresponding to the target permission level and the candidate permission level are determined as the target region categories corresponding to the target permission level. For example, if the target permission level is permission level 2, the candidate permission level may be permission level 3, referring to Table 1, region category 2 and region category 3 which correspond to permission level 2 and permission level 3 may be used as the target region categories corresponding to permission level 2. Referring to Table 2, region category 3, region category 4, region category 5, and region category 6, which correspond to permission level 2 and permission level 3, may be used as the target region categories corresponding to permission level 2. Referring to Table 3, region category 2, region category 3, region category 4, region category 5, and region category 6, which correspond to permission level 2 and permission level 3, may be used as the target region categories corresponding to permission level 2.

In a possible implementation, there may be at least one region category (a default region category) that can be accessed by all permission levels, referring to Table 5, which is an example of the mapping relationship for Table 1, referring to Table 6, which is an example of the mapping relationship for Table 2, and so on. In this case, the correspondence between the permission levels and the default region category does not need to be explicitly expressed, i.e., Table 5 may be consistent with the syntax of Table 1, and Table 6 may be consistent with the syntax of Table 2, but implicitly, all permissions are allowed to access the default region category.

TABLE 5

| permission levels | region categories |
|---|---|
| permission level 1 | region category 1, default region category |
| permission level 2 | region category 2, default region category |
| permission level 3 | region category 3, default region category |

TABLE 6

| permission levels | region categories |
|---|---|
| permission level 1 | region category 1, region category 2, default region |
| | category |
| permission level 2 | region category 3, region category 4, default region |
| | category |
| permission level 3 | region category 5, region category 6, default region |
| | category |

In Table 5 and Table 6, the default region category may be a preconfigured region category that can be accessed by all permission levels. If the current region category corresponding to the current coding unit is the default region category, it indicates that permission protection does not need to be performed on the region in which the current coding unit is located, and all permission levels can access the region in which the default region category is located. Therefore, it is sufficient that the current coding unit can be reconstructed by the reconstruction information without distinguishing between high-dimensional reconstruction information and low-dimensional reconstruction information. The encoder side encodes a bit stream corresponding to the current coding unit, where the bit stream includes reconstruction information of the current coding unit. The decoder side decodes the bit stream corresponding to the current coding unit, parses out the reconstruction information of the current coding unit from the bit stream, and reconstructs the current coding unit based on the reconstruction information.

In Embodiment 1, Embodiment 2, and Embodiment 3, the encoder side needs to determine one or more target region categories, and in order to determine the target region categories, the following method may be used: obtaining the target region categories by querying the mapping relationship, where the target region category is a region category corresponding to the first permission level and not corresponding to the second permission level, i.e., at least one permission level corresponds to the target region category, and at least one permission level does not correspond to the target region category. For example, referring to Table 1, assuming that permission level 1>permission level 2>permission level 3, region category 1 corresponds to the first permission level (permission level 1) and does not correspond to the second permission level (permission level 2 and the permission level 3), so region category 1 is a target region category. Region category 2 corresponds to the first permission level (permission level 1 and permission level 2) and does not correspond to the second permission level (permission level 3), so region category 2 is a target region category. Region category 3 corresponds to all permission levels (permission level 1, permission level 2, and permission level 3), i.e., all permission levels have access permission of region category 3, which can view a picture region corresponding to region category 3, so region category 3 is not a target region category. Similarly, referring to Table 2, region category 1, region category 2, region category 3, and region category 4 are all target region categories, and region category 5 and region category 6 are not target region categories. Referring to Table 4, region category 1, region category 2, region category 3, and region category 4 are all target region categories, region category 5 and region category 6 are not target region categories, and so on.

Embodiment 7: Embodiment 7 is used to implement syntax design in region depiction. In Embodiment 1, Embodiment 2, and Embodiment 3, the encoder side and the decoder side further need to determine a current region category corresponding to a current coding unit, where the current coding unit may correspond to one current region category, or may correspond to a plurality of current region categories.

For example, the encoder side may acquire a region category identifier and region location information of one or more regions corresponding to the region category identifier; and for a current coding unit corresponding to the region location information, determining a region category corresponding to the region category identifier as a current region category corresponding to the current coding unit. The decoder side may acquire a region category identifier and region location information of one or more regions corresponding to the region category identifier; and for a current coding unit corresponding to the region location information, determining a region category corresponding to the region category identifier as a current region category corresponding to the current coding unit. The encoder side may further encode the region category identifier and the region location information of one or more regions corresponding to the region category identifier in the higher-level unit syntax of the current coding unit. On this basis, the decoder side may further decode the region category identifier and the region location information of one or more regions corresponding to the region category identifier from the higher-level unit syntax of the current coding unit. Alternatively, the encoder side may not encode the region category identifier and the region location information of the one or more regions corresponding to the region category identifier in the higher-level unit syntax of the current coding unit, and the decoder side may derive the region category identifier and the region location information of the one or more regions corresponding to the region category identifier according to the reconstruction data, which is not limited. Alternatively, the encoder side may not encode the region category identifier in the higher-level unit syntax of the current coding unit, but the encoder side encodes the region location information of the one or more regions corresponding to the region category identifier in the higher-level unit syntax of the current coding unit, and the decoder side may derive the region category identifier according to the reconstruction data, and decode the region location information of the one or more regions corresponding to the region category identifier from the higher-level unit syntax of the current coding unit, which is not limited. For example, the region category identifier may be implicitly derived without explicit transmission. For example, in a case of an agreed-upon sorting order, the decoder side may implicitly derive the region category identifier.

For example, an example of the higher-level unit syntax of the current coding unit may be 1 200 400 500 600, in the higher-level unit syntax, “1” represents a region category identifier, “200 400 500 600” represents the region location information corresponding to the region category identifier 1, and one region can be uniquely determined based on the region location information. On this basis, for the current coding unit corresponding to the region location information, the current region category corresponding to the current coding unit may be the region category 1 corresponding to the region category identifier 1.

For another example, an example of the higher-level unit syntax of the current coding unit may be 2 100 200 300 300 150 300 400 400 200 400 500 600, in the higher-level unit syntax, “2” represents a region category identifier, “100 200 300 300”, “150 300 400 400”, and “200 400 500 600” represent three pieces of region location information corresponding to the region category identifier 1, and three regions can be determined respectively through the three pieces of region location information. On this basis, for the current coding unit corresponding to the three pieces of region location information, the current region category corresponding to the current coding unit may be region category 2 corresponding to the region category identifier 2.

Embodiment 8: Embodiment 8 is used to implement syntax design in region depiction, and in Embodiment 1, Embodiment 2, and Embodiment 3, an encoder side and a decoder side further need to determine a current region category corresponding to a current coding unit. For example, the encoder side may acquire a region category identifier, a total quantity of picture regions corresponding to the region category identifier, and pieces of region location information as many as the total quantity of the picture regions; and for a current coding unit corresponding to the region location information, determine a region category corresponding to the region category identifier as the current region category corresponding to the current coding unit. The decoder side may acquire the region category identifier, the total quantity of picture regions corresponding to the region category identifier, and pieces of region location information as many as the total quantity of the picture regions; and for the current coding unit corresponding to the region location information, determine the region category corresponding to the region category identifier as the current region category corresponding to the current coding unit.

The encoder side may further encode, in the higher-level unit syntax of the current coding unit, the region category identifier, a total quantity of picture regions corresponding to the region category identifier, and pieces of region location information as many as the total quantity of the picture regions. On this basis, the decoder side may further decode, from the higher-level unit syntax of the current coding unit, the region category identifier, a total quantity of picture regions corresponding to the region category identifier, and pieces of region location information as many as the total quantity of the picture regions. Alternatively, the encoder side may not encode, in the higher-level unit syntax of the current coding unit, the region category identifier, a total quantity of picture regions corresponding to the region category identifier, and pieces of region location information as many as the total quantity of the picture regions, while according to the reconstruction data, the decoder side may derive the region category identifier, the total quantity of picture regions corresponding to the region category identifier, and the pieces of region location information as many as the total quantity of the picture regions, which is not limited. Alternatively, the encoder side may not encode the region category identifier in the higher-level unit syntax of the current coding unit, but encodes, in the higher-level unit syntax of the current coding unit, the total quantity of picture regions corresponding to the region category identifier and the pieces of region location information as many as the total quantity of the picture regions, while according to the reconstruction data, the decoder side may derive the region category identifier, and decode, from the higher-level unit syntax of the current coding unit, the total quantity of picture regions corresponding to the region category identifier and the pieces of region location information as many as the total quantity of the picture regions, which is not limited. For example, the region category identifier may be implicitly derived without explicit transmission. For example, in a case of an agreed-upon sorting order, the decoder side may implicitly derive the region category identifier.

For example, an example of higher-level unit syntax of the current coding unit may be 1 1 200 400 500 600, in the higher-level unit syntax, the first “1” represents the region category identifier, the second “1” represents the total quantity of picture regions corresponding to the region category identifier, and “200 400 500 600” represents the region location information corresponding to the region category identifier 1, and one region can be uniquely determined according to the region location information. On this basis, the decoder side learns, based on the first “1”, that the region category identifier is 1, and learns, based on the second “1”, that one piece of region location information needs to be parsed out; and for a current coding unit corresponding to the region location information, a current region category corresponding to the current coding unit may be region category 1 corresponding to the region category identifier 1.

For another example, an example of the higher-level unit syntax of the current coding unit may be 2 3 100 200 300 300 150 300 400 400 200 400 500 600, in the higher-level unit syntax, “2” represents a region category identifier, “3” represents a total quantity of picture regions corresponding to the region category identifier, and “100 200 300 300”, “150 300 400 400”, and “200 400 500 600” represent three pieces of region location information corresponding to the region category identifier 1, and three regions can be determined respectively through the three pieces of region location information. On this basis, the decoder side learns, based on “1”, that the region category identifier is 2, and learns, based on “3”, that three pieces of region location information need to be parsed out, and for a current coding unit corresponding to the three pieces of region location information, the decoder side determines that a current region category corresponding to the current coding unit may be region category 2 corresponding to the region category identifier 2.

In summary, it may be seen that, the syntax design in the region depiction may be: the region category index value+the quantity of shapes of the current region category+the specific pattern, the region category index value may be the region category identifier, the quantity of shapes of the current region category may be the total quantity of picture regions corresponding to the region category identifier, the specific pattern may be the pattern of the region location information, and the pattern of the region location information may refer to the subsequent embodiments.

In a possible implementation, in Embodiment 7 and Embodiment 8, for the region location information corresponding to each region category identifier, a total quantity of pieces of region location information may be further limited, i.e., the total quantity of pieces of region location information needs to be not greater than a preset quantity threshold, and the preset quantity threshold may be configured according to experience, e.g., 16, 32, or 64. If 64 is taken as an example, the pieces of region location information corresponding to the region category identifier are required to be not more than 64.

In Embodiment 8, the total quantity of picture regions (representing the total quantity of pieces of region location information) is required to be not greater than a preset quantity threshold, and the preset quantity threshold may be configured according to experiences, e.g., 16, 32, and 64. If 64 is taken as an example, the total quantity of picture regions is required to be not greater than 64, so that at most 64 regions can be depicted.

In a possible implementation, for Embodiment 7 and Embodiment 8, a total quantity of region category identifiers may be further limited, i.e., the total quantity of region category identifiers needs to be not greater than a threshold, and the threshold may be configured based on experience, e.g., 4, 8, or 16, i.e., the total quantity of region category identifiers cannot exceed the threshold.

Obviously, by simultaneously limiting the total quantity of region category identifiers and the total quantity of picture regions corresponding to the region category identifiers, the total quantity of all region location information corresponding to all region category identifiers can be limited.

Embodiment 9: Embodiment 9 is used to implement syntax design in region depiction, and on the basis of Embodiment 7 or Embodiment 8 (e.g., on the basis of Embodiment 8), the encoder side and the decoder side further need to determine a current region category corresponding to a current coding unit, and in Embodiment 7 and Embodiment 8, the current coding unit corresponds to one current region category, while in Embodiment 9, the current coding unit corresponds to a plurality of current region categories.

For example, the encoder/decoder may acquire a region category identifier, a total quantity of picture regions corresponding to the region category identifier, pieces of region location information as many as the total quantity of the picture regions, and a combination identifier corresponding to the region category identifier. The combination identifier indicates whether one or more associated region category identifiers for a combination operation with the region category identifier exist. If the combination identifier indicates that one or more associated region category identifiers for a combination operation with the region category identifier exist, the encoder/decoder may acquire the associated region category identifiers corresponding to the region category identifier. If the combination identifier indicates that one or more associated region category identifiers for a combination operation with the region category identifier do not exist, the encoder/decoder does not acquire the associated region category identifiers corresponding to the region category identifier.

If the combination identifier is the first value, the combination identifier indicates that an associated region category identifier for the combination operation with the region category identifier exists; and if the combination identifier is the second value, the combination identifier indicates that no associated region category identifiers for the combination operation with the region category identifier exist.

For the current coding unit corresponding to the region location information corresponding to the region category identifier, the region category corresponding to the region category identifier is determined as the current region category corresponding to the current coding unit.

For the coding unit corresponding to the region location information corresponding to the associated region category identifier, the region category corresponding to the region category identifier and the region category corresponding to the associated region category identifier are determined as the region categories corresponding to the coding unit, i.e., the region category corresponding to the coding unit may be a plurality of region categories.

The encoder side may further encode, in the higher-level unit syntax of the current coding unit, a region category identifier, a total quantity of picture regions corresponding to the region category identifier, pieces of region location information as many as the total quantity of the picture regions, a combination identifier corresponding to the region category identifier, and one or more associated region category identifiers corresponding to the region category identifier. On this basis, the decoder side may further decode, from the higher-level unit syntax of the current coding unit, the region category identifier, the total quantity of picture regions corresponding to the region category identifier, the pieces of region location information as many as the total quantity of the picture regions, the combination identifier corresponding to the region category identifier, and the one or more associated region category identifiers corresponding to the region category identifier. Alternatively, the encoder side may not encode the foregoing syntax information in the higher-level unit syntax of the current coding unit, while according to the reconstruction data, the decoder side may derive the region category identifier, the total quantity of picture regions corresponding to the region category identifier, the pieces of region location information as many as the total quantity of the picture regions, the combination identifier corresponding to the region category identifier, and the associated region category identifiers corresponding to the region category identifier, which is not limited.

For example, an example of the higher-level unit syntax of the current coding unit may be 4 1 200 400 500 600 1 0 2 3, in the higher-level unit syntax, “4” represents a region category identifier, the first “1” represents a total quantity of picture regions corresponding to the region category identifier 4, and “200 400 500 600” represents region location information corresponding to the region category identifier 4, and one region can be uniquely determined by using the region location information. The second “1” represents a combination identifier, the combination identifier indicates that an associated region category identifier for a combination operation with the region category identifier 4, and “0 2 3” is used to represent three associated region category identifiers.

On this basis, the decoder side learns, based on “4”, that the region category identifier is 4, and learns, based on the first “1”, that one piece of region location information needs to be parsed out; and for a current coding unit corresponding to the region location information, a current region category corresponding to the current coding unit may be region category 4 corresponding to the region category identifier 4.

The decoder side learns, based on the second “1”, that the combination identifier indicates that associated region category identifiers for the combination operation with the region category identifier 4, i.e., the associated region category identifiers are 0, 2, and 3. On this basis, for the coding unit corresponding to the region location information (learned from the syntax of the region category identifier 0) corresponding to the associated region category identifier 0, the current region categories corresponding to the coding unit may be region category 4 corresponding to the region category identifier 4 and region category 0 corresponding to the associated region category identifier 0. For the coding unit corresponding to the region location information corresponding to the associated region category identifier 2, the current region categories corresponding to the coding unit may be region category 4 corresponding to the region category identifier 4 and region category 2 corresponding to the associated region category identifier 2. For the coding unit corresponding to the region location information corresponding to the associated region category identifier 3, the current region categories corresponding to the coding unit may be region category 4 corresponding to the region category identifier 4 and region category 3 corresponding to the associated region category identifier 3. Obviously, there may be a plurality of current region categories corresponding to the coding unit.

Embodiment 10: Embodiment 10 is used to implement syntax design in region depiction, and on the basis of Embodiment 7 or Embodiment 8 (subsequent description is made on the basis of Embodiment 8 as an example), the encoder side and the decoder side further need to determine current region categories corresponding to the current coding unit, e.g., the current coding unit corresponds to a plurality of current region categories.

For example, the encoder/decoder may acquire a region category identifier, a total quantity of picture regions corresponding to the region category identifier, pieces of region location information as many as the total quantity of the picture regions, and a combination identifier corresponding to the region category identifier. The combination identifier indicates whether an associated region category identifier for combination operation with the region category identifier exists. If the combination identifier indicates that the associated region category identifiers for the combination operation with the region category identifier exist, the encoder/decoder side may acquire a total quantity of category identifiers corresponding to the associated region category identifiers and the total quantity of associated region category identifiers corresponding to the region category identifier. If the combination identifier indicates that one or more associated region category identifiers for a combination operation with the region category identifier do not exist, the encoder/decoder does not acquire the associated region category identifiers corresponding to the region category identifier.

On this basis, for the current coding unit corresponding to the region location information corresponding to the region category identifier, the region category corresponding to the region category identifier is determined as the current region category corresponding to the current coding unit. For the coding unit corresponding to the region location information corresponding to the associated region category identifier, the region category corresponding to the region category identifier and the region category corresponding to the associated region category identifier are determined as the region categories corresponding to the coding unit, i.e., the coding unit may correspond to a plurality of region categories.

The encoder side may further encode, in the higher-level unit syntax of the current coding unit, a region category identifier, a total quantity of picture regions corresponding to the region category identifier, pieces of region location information as many as the total quantity of the picture regions, a combination identifier corresponding to the region category identifier, a total quantity of category identifiers corresponding to associated region category identifiers, and associated region category identifiers as many as the total quantity of category identifiers. The decoder side may decode, from the higher-level unit syntax of the current coding unit, the region category identifier, the total quantity of picture regions corresponding to the region category identifier, the pieces of region location information as many as the total quantity of the picture regions, the combination identifier corresponding to the region category identifier, the total quantity of category identifiers corresponding to associated region category identifiers, and associated region category identifiers as many as the total quantity of category identifiers. Alternatively, the encoder side may not encode the foregoing syntax information in the higher-level unit syntax of the current coding unit, while according to the reconstruction data, the decoder side may derive the region category identifier, the total quantity of picture regions corresponding to the region category identifier, the pieces of region location information as many as the total quantity of the picture regions, the combination identifier corresponding to the region category identifier, and the associated region category identifiers corresponding to the region category identifier, which is not limited.

For example, an example of the higher-level unit syntax of the current coding unit may be 4 1 200 400 500 600 1 3 0 2 3, in the higher-level unit syntax, “4” represents the region category identifier, the first “1” represents the total quantity of picture regions corresponding to the region category identifier 4, “200 400 500 600” represents the region location information corresponding to the region category identifier 4, the second “1” represents the combination identifier and indicates that one or more associated region category identifiers for the combination operation exist, the first “3” represents that there are three associated region category identifiers in total, i.e., three associated region category identifiers need to be parsed out, and “0 2 3” represents the three associated region category identifiers.

In summary, it may be seen that, a syntax design in the region depiction may be: the region category index value+the quantity of shapes of the current region category+the specific pattern+the combination identifier+the combination quantity X+X quantity of region index values, where the region category index value may be a region category identifier, the quantity of shapes of the current region category may be the total quantity of picture regions corresponding to the region category identifier, and the specific pattern may be the pattern of region location information, where the combination identifier indicates whether an associated region category identifier for a combination operation with the region category identifier exists, the combination quantity X indicates the quantity of associated region category identifiers, and the X quantity of region index values indicate X quantity of associated region category identifiers.

In the above embodiment, the region combination operation may be limited to be performed only with the same-level permission region, or only with the same-level permission region and the lower-level permission region, that is to say, the permission level corresponding to the associated region category identifier is equal to the permission level corresponding to the region category identifier; or, the permission level corresponding to the associated region category identifier is lower than the permission level corresponding to the region category identifier.

Embodiment 11: Embodiment 11 is used to implement pattern design in region depiction. Embodiment 1-Embodiment 3, and Embodiment 7-Embodiment 10, all relate to region location information corresponding to a region category identifier, and the region location information may include, but is not limited to region location information of a polygonal region, a rectangular region, or a circular region. Certainly, other shapes may also be used, e.g., an irregular quadrangle, or a sector, which is not limited herein. It should be noted that, in Embodiment 1 to Embodiment 3 and Embodiment 7 to Embodiment 10, if a plurality of region forms need to be supported at the same time, e.g., rectangular region depiction and circular region depiction exist at the same time, a syntax identifier of a description type needs to be additionally transmitted, representing rectangular region depiction or circular region depiction.

Application scenario 1: for region location information of a polygonal region (e.g., arbitrary shapes such as an irregular quadrilateral and a diamond), the region location information may include the coordinates of at least one vertex relative to a preset origin; for example, the region location information may include the coordinates of all vertexes of the polygonal region relative to the preset origin.

Application scenario 2: for the region location information of the rectangular region, the region location information may include the coordinates of at least one vertex relative to the preset origin; for example, the region location information may include coordinates of all vertexes of the rectangular region relative to the preset origin, e.g., the coordinates of four vertexes of the rectangular region.

Application scenario 3: for region location information for a rectangular region, the region location information includes coordinates of an upper-left corner point and coordinates of a lower-right corner point of the rectangular region relative to a preset origin; or the region location information includes coordinates of a lower-left corner point and coordinates of an upper-right corner point of the rectangular region relative to the preset origin; or the region location information includes coordinates of any corner (e.g., coordinates of the upper-left corner point, coordinates of the lower-left corner point, coordinates of the upper-right corner point, and coordinates of the lower-right corner point) of the rectangular region relative to the preset origin, a width of the rectangular region, and a height of the rectangular region.

Application scenario 4: for a circular region, the region location information may include center coordinates of the circular region relative to a preset origin and a radius of the circular region, i.e., circular depiction through the center coordinates and the radius.

In the foregoing embodiment, the coordinates refer to coordinates relative to a preset origin (e.g., coordinates of a vertex of a polygonal region relative to the preset origin, coordinates of a vertex of a rectangular region relative to the preset origin, and coordinates of a center of a circular region relative to the preset origin), and the preset origin may be any one coordinate point in the current picture.

For example, an upper-left coordinate point in the current picture may be used as the preset origin. Alternatively, the encoder side may use any coordinate point in the current picture as the preset origin, and encode information (indicating which coordinate point in the current picture is used as the preset origin) about the preset origin in the bit stream, and the decoder side decodes the information about the preset origin from the bit stream, and then learns which coordinate point in the current picture is used as the preset origin. Alternatively, the preset origin may be an upper-left corner point of preset M*N rectangular division, and the preset M*N rectangular division may be LCU division, CU division, or division in another manner, which is not limited.

For example, the current picture may be divided into a plurality of LCUs, each LCU may be a rectangle with the size of M*N, M may be greater than or equal to the minimum size of the coding units, and N may be greater than or equal to the minimum size of the coding units. On this basis, the upper-left corner point of the preset LCU (preset M*N rectangle) may be used as the preset origin. Assuming that each region (i.e., the region corresponding to the region location information) corresponding to the region category identifier is located in LCU1, the upper-left corner point of the LCU1 is used as the preset origin; and assuming that each region corresponding to the region category identifier is located in LCU2, the upper-left corner point of LCU2 is used as the preset origin, and so on.

For example, referring to FIG. 5, assuming that each region corresponding to the region category identifiers (e.g., 0, 1, and 2) are all located in the black rectangular frame, the upper-left corner point of the black rectangular frame may be used as the preset origin.

Embodiment 12: Embodiment 12 is used to implement pattern design in region depiction. Embodiment 1-Embodiment 3, and Embodiment 7-Embodiment 10, all relate to region location information corresponding to a region category identifier, and in order to determine the region location information corresponding to the region category identifier, a plurality of picture units may be arranged in a preset scanning order. On this basis, the region location information may include a start picture unit index and an end picture unit index relative to a preset origin; or the region location information may include a start picture unit index relative to a preset origin and a total quantity of picture units of the current region; or the region location information may include an end picture unit index relative to a preset origin and a total quantity of picture units of the current region.

For example, the current picture may be divided into a plurality of picture units, and the picture unit may be a coding unit, i.e., each coding unit may be used as a picture unit. Alternatively, the picture unit may be an A*B picture unit obtained through division in a preset division manner, i.e., the current picture may be divided into a plurality of picture units with the size of A*B, the size of each picture unit is A*B, A may be greater than or equal to the minimum size of coding units, e.g., 4, or 8, and B may be greater than or equal to the minimum size of coding units, e.g., 4, or 8.

Then, all picture units are arranged in a preset scanning order, e.g., these picture units are arranged in an order according to a certain rule (raster scanning, Hilbert scanning, etc.), i.e., forming a one-dimensional form.

The preset origin may correspond to any one of all the picture units, e.g., when the preset origin is 0, it indicates the first picture unit of all the picture units, when the preset origin is 1, it indicates the second picture unit of all the picture units, and so on. The encoder side may encode information about the preset origin (indicating which picture unit in the current picture is used as the preset origin) in the bit stream, and the decoder side obtains the information about the preset origin by decoding the bit stream, and then learns which picture unit in the current picture is used as the preset origin. Alternatively, the preset origin may be a default origin, e.g., the first picture unit is used as the preset origin.

The preset origin may also be an upper-left corner point of preset M*N rectangular division (i.e., the picture unit at the upper-left corner is used as the preset origin), where the preset M*N rectangular division may include, but is not limited to an LCU division, or certainly may be a CU division, or may be division in other manners, which is not limited.

For example, the current picture may be divided into a plurality of LCUs, each LCU may be a rectangle with the size of M*N, M may be greater than or equal to the minimum size of the coding units, and N may be greater than or equal to the minimum size of the coding units. On this basis, the upper-left corner point (i.e., the picture unit at the upper-left corner) of the preset LCU may be used as the preset origin. Assuming that each picture unit corresponding to the region category identifier is located in LCU1, the upper-left corner point of LCU1 is taken as the preset origin; and assuming that each picture unit corresponding to the region category identifier is located in LCU2, the upper-left corner point of LCU2 is taken as the preset origin, and so on.

For example, referring to FIG. 5, assuming that the picture units corresponding to the region category identifiers (e.g., 0, 1, and 2) are all located in the black rectangular frame, the upper-left corner point of the black rectangular frame may be used as the preset origin, i.e., the information of the circumscribed rectangular frame may be transmitted first, and then the foregoing internal region is depicted.

For example, the region location information may be described in one dimension through the start point and the end point, i.e., the region location information may include the start picture unit index and the end picture unit index relative to the preset origin. For example, if the preset origin is 0, the start picture unit index is 3, and the end picture unit index is 6, it indicates that the region location information corresponds to the 3rd-6th picture units. If the preset origin is 1, the start picture unit index is 3, and the end picture unit index is 6, it indicates that the region location information corresponds to the 4th-7th picture units.

For example, the region location information may be described in one dimension through the start point and the end point, i.e., the region location information may include the start picture unit index and the end picture unit index relative to the preset origin. For example, if the preset origin is 0, the start picture unit index is 3, and the total quantity of picture units in the current region is 3, it indicates that the region location information corresponds to the 3th-5th picture units (three picture units in total). If the preset origin is 1, the start picture unit index is 3, and the total quantity of picture units in the current region is 5, it indicates that the region location information corresponds to the 4th-8th picture units (5 picture units in total), and so on.

For example, the region location information may be described in one dimension through an end point and a length, i.e., the region location information may include an end picture unit index relative to a preset origin and a total quantity of picture units in the current region. For example, if the preset origin is 0, the end picture unit index is 6, and the total quantity of picture units in the current region is 3, it indicates that the region location information corresponds to the 3th-5th picture units (three picture units in total).

In a possible implementation, if the region category identifier corresponds to region location information of a plurality of regions, the end picture unit of region location information of the previous region is used as the preset origin corresponding to the region location information of the current region, i.e., the transmission cost value is reduced by transferring the difference between the start point of the current region and the end point of the previous region.

For example, when the region location information is described in one dimension through the start point and the end point, the preset origin of the first piece of region location information is 0, the start picture unit index is 3, and the end picture unit index is 6; assuming that the preset origin of the second piece of region location information is 0, the start picture unit index is 8, and the end picture unit index is 12, by using the end picture unit of the first piece of region location information as the preset origin corresponding to the second piece of region location information, the preset origin of the second piece of region location information is S (which may be derived by the decoder and is not carried in the bit stream), the start picture unit index is 2, and the end picture unit index is 6.

For another example, when the region location information is described in one dimension through the start point and the length, the preset origin of the first piece of region location information is 0, the start picture unit index is 3, and the total quantity of picture units in the current region is 4; assuming that the preset origin of the second piece of region location information is 0, the start picture unit index is 8, and the total quantity of picture units in the current region is 5, then by using the end picture unit of the first piece of region location information as the preset origin corresponding to the second piece of region location information, the preset origin of the second piece of region location information is 5, the index of the start picture unit is 2, and the total quantity of picture units in the current region is 5.

Embodiment 13: Embodiment 13 is used to implement syntax design and pattern design in region depiction. In Embodiment 1-Embodiment 3, the encoder side and the decoder side further need to determine a current region category corresponding to a current coding unit, where the current coding unit may correspond to only one current region category, and certainly, the current coding unit may also correspond to a plurality of current region categories, which is not limited. For example, the encoder and the decoder may acquire a region category identifier corresponding to each picture unit, and may determine, based on region category identifiers corresponding to picture units covered by the current coding unit, the region category corresponding to the highest permission level in the region category identifiers as the current region category corresponding to the current coding unit, i.e., acquiring a current region category corresponding to the current coding unit.

For example, the current picture may be divided into a plurality of picture units by adopting a MAP/MASK form, i.e., regular division (e.g., divided into a plurality of A*B blocks) is performed on the current picture, and the picture unit may be an A*B picture unit obtained through division in a preset division manner, i.e., the current picture may be divided into a plurality of picture units with the size of A*B, the size of each picture unit is A*B, A may be greater than or equal to the minimum size of a coding unit, e.g., 4, or 8, and B may be greater than or equal to the minimum size of a coding unit, e.g., 4, or 8.

For another example, the current picture may be divided into a plurality of picture units by adopting a unit level description form, various units, e.g., coding units, exist in an encoding/decoding process, and region description may be performed in a manner that each coding unit corresponds to a region category identifier, that is to say, the picture unit may be a coding unit, i.e., each coding unit may be used as a picture unit, and the coding unit is each to-be-processed picture block in the current picture.

Then, a region category identifier corresponding to each picture unit is determined, and assuming that there are five region category identifiers, e.g., 0, 1, 2, 3, and 4, the region category identifier corresponding to each picture unit may be 0, 1, 2, 3, or 4, i.e., the region category identifiers of all picture units may be described.

For example, for the encoder side, a region category identifier corresponding to each picture unit may be determined, and the region category identifier corresponding to each picture unit is encoded in the higher-level unit syntax of the current coding unit. For the decoder side, the region category identifier corresponding to each picture unit may be decoded from the higher-level unit syntax of the current coding unit, to obtain the region category identifier corresponding to each picture unit. Alternatively, the encoder may not encode the region category identifier corresponding to each picture unit in the higher-level unit syntax of the current coding unit, and the decoder may derive the region category identifier corresponding to each picture unit according to the reconstruction data, which is not limited.

Assuming that there are 32 picture units, and the region category identifiers corresponding to the 32 picture units may refer to FIG. 6, i.e., the region category identifiers corresponding to six picture units are 1, the region category identifiers corresponding to the remaining 26 picture units are 0, and the positional relationship of these picture units may refer to FIG. 6.

For the encoder side and the decoder side, after obtaining the region category identifier corresponding to each picture unit, when encoding or decoding the current coding unit, the region category identifiers corresponding to the picture units covered by the current coding unit may be determined. If the current coding unit covers only one picture unit, a region category corresponding to the region category identifier corresponding to the picture unit is determined as the current region category corresponding to the current coding unit.

If the current coding unit covers a plurality of picture units, based on the region category identifiers corresponding to each image unit covered by the current coding unit, the region category corresponding to the highest permission level in the region category identifiers may be determined as the current region category corresponding to the current coding unit. For example, assuming that the current coding unit is 16*8, and the current coding unit includes picture unit 1 of 8*8 and picture unit 2 of 8*8, if the permission level corresponding to the region category identifier of picture unit 1 is higher than the permission level corresponding to the region category identifier of picture unit 2, the region category corresponding to the region category identifier corresponding to picture unit 1 is determined as the current region category corresponding to the current coding unit. If the permission level corresponding to the region category identifier of picture unit 2 is higher than the permission level corresponding to the region category identifier of picture unit 1, the region category corresponding to the region category identifier corresponding to picture unit 2 is determined as the current region category corresponding to the current coding unit. If the permission level corresponding to the region category identifier of picture unit 1 is equal to the permission level corresponding to the region category identifier of picture unit 2, the region category corresponding to the region category identifier corresponding to picture unit 1 may be determined as the current region category corresponding to the current coding unit, or the region category corresponding to the region category identifier corresponding to picture unit 2 may be determined as the current region category corresponding to the current coding unit, or both the region category corresponding to the region category identifier corresponding to picture unit 1 and the region category corresponding to the region category identifier corresponding to picture unit 2 may be determined as the current region categories corresponding to the current coding unit, i.e., the quantity of the current region categories corresponding to the current coding unit may be two. Certainly, if the region category corresponding to the region category identifier corresponding to picture unit 1 corresponds to the same region category as the region category identifier corresponding to picture unit 2, the current region category corresponds to one current coding unit.

Embodiment 14: Embodiment 14 is used to implement syntax design and pattern design in region depiction. In Embodiment 1-Embodiment 3, the encoder side and the decoder side further need to determine a current region category corresponding to a current coding unit, e.g., one current region category or a plurality of current region categories. For the encoder side and the decoder side, a region category identifier and region indication information may be acquired, where the region indication information indicates a plurality of picture units, and the region category identifier is determined as a region category identifier corresponding to the plurality of picture units. On this basis, based on the region category identifier corresponding to the picture units covered by the current coding unit, the region category corresponding to the highest permission level in the region category identifiers may be determined as the current region category corresponding to the current coding unit.

For example, the current picture may be divided into a plurality of picture units by adopting a MAP/MASK form, i.e., regular division (e.g., divided into a plurality of A*B blocks) is performed on the current picture, and the picture unit may be an A*B picture unit obtained through division in a preset division manner, or the current picture may be divided into a plurality of picture units by adopting a unit level description form, e.g., each coding unit may be used as a picture unit, which is not limited herein.

For the encoder side, a region category identifier corresponding to each picture unit is determined, and assuming that there are five region category identifiers, e.g., 0, 1, 2, 3, and 4, the region category identifier corresponding to each picture unit may be 0, 1, 2, 3, or 4, i.e., the region category identifiers of all picture units may be described.

For the encoder side, the encoder side may further determine region indication information, where the region indication information indicates a plurality of picture units. On this basis, the encoder side may encode a region category identifier and region indication information corresponding to the region category identifier in the higher-level unit syntax of the current coding unit.

The decoder side may decode the region category identifier and the region indication information corresponding to the region category identifier from the higher-level unit syntax of the current coding unit, to obtain the region category identifier and the region indication information. Alternatively, the encoder side may not encode the region category identifier and the region indication information in the higher-level unit syntax of the current coding unit, and the decoder side may derive the region category identifier and the region indication information according to reconstruction data.

The region indication information indicates a plurality of picture units, and therefore, the decoder side may determine the region category identifier as a region category identifier corresponding to the plurality of picture units indicated by the region indication information.

In a possible implementation, the region indication information may include start point coordinates relative to a preset origin, at least one direction identifier, a length corresponding to each direction identifier, and an end flag; where the start point coordinates indicate a picture unit corresponding to a region category identifier (i.e., the start point coordinates indicate which picture unit in all picture units), the direction identifier indicates a direction of picture units belonging to the same region category, a length corresponding to each direction identifier indicates a quantity of picture units in the direction of the picture units belonging to the same region category, and the end flag indicates that a plurality of picture units have been completed.

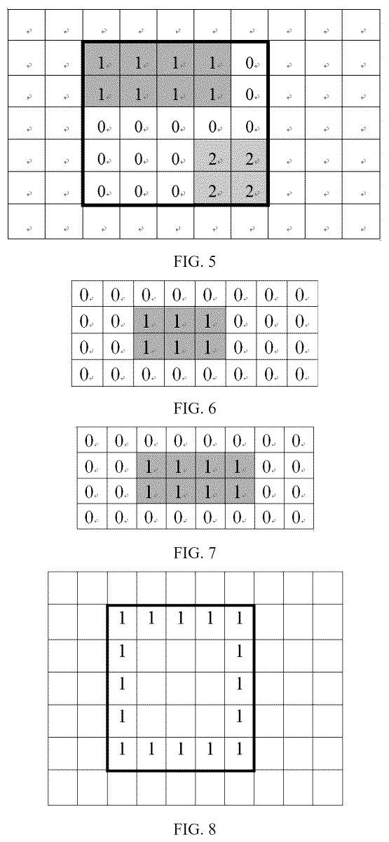

For example, the length corresponding to each direction identifier may be fixed to 1, and in this case, the higher-level unit syntax of the current coding unit may not carry a length corresponding to each direction identifier, and the decoder side may determine that the length corresponding to each direction identifier is 1. Assuming that there are 32 picture units, the region category identifiers corresponding to the 32 picture units may be referred from FIG. 7. On this basis, the start point coordinates relative to the preset origin represent the third picture unit of the second row, e.g., the start point coordinates (2, 3) represent the third picture unit of the start point. At least one direction identifier may be sequentially: right, right, right, down, left, left, and left, and different direction identifiers may represent different directions, e.g., 00 represents right, 01 represents left, 10 represents down, and 11 represents up. In summary, the region indication information may include sequentially: 2, 3, 00, 00, 00, 10, 01, 01, 01, and an end flag. Based on the above region indication information, the first picture unit (the third picture unit of the second row) is found through the start point coordinates (2,3), the second picture unit (the fourth picture unit of the second row) is found through the first “00”, the third picture unit (the fifth picture unit of the second row) is found through the second “00”, the fourth picture unit (the sixth picture unit of the second row) is found through the third “00”, the fifth picture unit (the sixth picture unit in the third row) is found through “10”, the sixth picture unit (the fifth picture unit of the third row) is found through the first “01”, the seventh picture unit (the fourth picture unit of the third row) is found through the second “01”, the eighth picture unit (the third picture unit of the third row) is found through the third “01”, and the indication that the plurality of picture units have been completed is obtained through the end flag. So far, eight picture units are obtained, and the region category identifier may be determined as the region category identifier corresponding to the eight picture units, i.e., only one region category identifier needs to be transmitted, and the region category identifier corresponding to the eight picture units is obtained.

For another example, the length corresponding to each direction identifier may be a variable value, and in this case, the higher-level unit syntax of the current coding unit carries a length corresponding to each direction identifier, and the decoder side needs to determine a length corresponding to each direction identifier. Referring to FIG. 7, the start point coordinates relative to the preset origin are used to represent the third picture unit of the second row, e.g., the third picture unit of the second row is represented by the start point coordinates (2,3). At least one direction identifier may be sequentially: right, down, and left, and different direction identifiers may represent different directions, e.g., 00 represents right, 01 represents left, 10 represents down, and 11 represents up. In summary, the region indication information may include sequentially: 2, 3, 00, 3, 10, 1, 01, 3, and an end flag. Based on the above region indication information, the first picture unit (the third picture unit of the second row) is found through the coordinates (2,3) of the start point, the second picture unit (the fourth picture unit of the second row), the third picture unit (the fifth picture unit of the second row) and the fourth picture unit (the sixth picture unit of the second row) are found through “00” and the length 3 (representing three consecutive picture units), the fifth picture unit (the sixth picture unit in the third row) is found through “10” and the length 1, the sixth picture unit (the fifth picture unit of the third row), the seventh picture unit (the fourth picture unit of the third row) and the eighth picture unit (the third picture unit of the third row) are found through “01” and the length 3, and the indication that the plurality of picture units have been completed is obtained through the end flag. So far, eight picture units are obtained, and the region category identifier may be determined as the region category identifier corresponding to the eight picture units, i.e., only one region category identifier needs to be transmitted, and the region category identifier corresponding to the eight picture units is obtained.

In summary, the region category identifier corresponding to the picture unit may be described in a drawing form, and in this case, an additional end flag is required to indicate the end of the form description. For example, the start point coordinates, the direction identifier, and the end flag may be indicated by the region indication information, or the start point coordinates, the direction identifier, and the length corresponding to the direction identifier, and the end flag may be indicated by the region indication information.

In the foregoing embodiment, the preset origin may correspond to any one of all the picture units, e.g., when the preset origin is 0, it indicates the first picture unit of all the picture units, when the preset origin is 1, it indicates the second picture unit of all the picture units, and so on. The encoder side may encode information about the preset origin (indicating which picture unit in the current picture is used as the preset origin) in the bit stream, and the decoder side obtains the information about the preset origin by decoding the bit stream, and then learns which picture unit in the current picture is used as the preset origin. Alternatively, the preset origin may be a default origin, e.g., the first picture unit is used as the preset origin. Alternatively, the preset origin may be an upper-left corner point of preset M*N rectangular division (i.e., the picture unit at the upper-left corner is used as the preset origin), where the preset M*N rectangular division may include, but is not limited to an LCU division, or certainly may be a CU division, or may be division in other manners, which is not limited.

For example, the current picture may be divided into a plurality of LCUs, each LCU may be a rectangle with the size of M*N, M may be greater than or equal to the minimum size of the coding units, and N may be greater than or equal to the minimum size of the coding units. On this basis, the upper-left corner point (i.e., the picture unit at the upper-left corner) of the preset LCU may be used as the preset origin. Assuming that each picture unit corresponding to the region category identifier is located in LCU1, the upper-left corner point of LCU1 is taken as the preset origin; and assuming that each picture unit corresponding to the region category identifier is located in LCU2, the upper-left corner point of LCU2 is taken as the preset origin, and so on.

For example, referring to FIG. 5, assuming that the picture units corresponding to the region category identifiers (e.g., 0, 1, and 2) are all located in the black rectangular frame, the upper-left corner point of the black rectangular frame may be used as the preset origin, i.e., the information of the circumscribed rectangular frame may be transmitted first, and then the foregoing internal region is depicted.

In a possible implementation, for the decoder side, a target shape enclosed by a plurality of picture units indicated by the region indication information may be further determined, so that the region category identifier may be determined as a region category identifier corresponding to picture units in the target shape. For example, referring to FIG. 8, the region indication information indicates 16 picture units corresponding to 16 “1”'5, e.g., indicating the 16 picture units through the start point coordinates relative to the preset origin, the at least one direction identifier, a length corresponding to each direction identifier, and the end flag, and after obtaining the region indication information, the decoder side may determine the 16 picture units indicated by the region indication information, and then determine a target shape (i.e., a rectangular region) enclosed by the 16 picture units, so that the region category identifier may be determined as a region category identifier corresponding to all picture units in the target shape, i.e., the region category identifier is determined as a region category identifier corresponding to 25 picture units.

For the encoder side and the decoder side, after obtaining the region category identifier corresponding to each picture unit (see the above obtaining method in Embodiment 14), when encoding or decoding the current coding unit, the region category identifiers corresponding to the picture units covered by the current coding unit may be determined. If the current coding unit covers only one picture unit, a region category corresponding to the region category identifier corresponding to the picture unit is determined as the current region category corresponding to the current coding unit. If the current coding unit covers a plurality of picture units, based on the region category identifiers corresponding to each image unit covered by the current coding unit, the region category corresponding to the highest permission level in the region category identifiers may be determined as the current region category corresponding to the current coding unit.

In a possible implementation, Embodiment 1-Embodiment 14 all relate to a region category corresponding to a picture region. On this basis, a default region may further be set. For example, if a rectangular region is used to depict the region location information, a region other than the rectangular region may be used as the default region, and if a circular region is used to depict the region location information, a region other than the circular region may be used as the default region. If both the rectangular region depiction and the circular region depiction are used, a region other than the rectangular region and the circular region may be used as the default region. For the default region, if the current coding unit corresponds to the default region, the current region category corresponding to the current coding unit is the default region category, indicating that permission protection does not need to be performed on the region in which the current coding unit is located.

Embodiment 15: Embodiment 15 is used to implement a level transferring in region depiction, and a permission region may be transferred by using several syntax, and may be transferred at a sequence level, sequence level extension data, a picture level, picture level extension data, a slice level, a tile level, a patch level, an LCU level, etc. A syntax used to manage or control several pictures may be referred to as a sequence-level or sequence-level extension data; a syntax used to manage or control a single-frame picture may be referred to as a picture-level or picture-level extension data; a syntax used to manage or control a parallel unit (i.e., a picture region) including several coding units may be referred to as a slice level, a tile level, or a patch level; a syntax used to manage or control the largest coding unit may be referred to as an LCU level; and a syntax used to manage or control a control unit may be referred to as a control unit level. A control unit may include a plurality of largest coding units, or a largest coding unit may include a plurality of control units. For example, Embodiment 1-Embodiment 14 relate to the higher-level unit syntax of the current coding unit, and the higher-level unit may include, but is not limited to: an LCU, a patch, a slice, a tile, a picture, or a sequence, where the current coding unit is located, which is not limited. In summary, the sequence-level syntax may be used as the higher-level unit syntax of the current coding unit to transmit the information in the foregoing embodiments; or the sequence-level extension data syntax may be used as the higher-level unit syntax of the current coding unit to transmit the information in the foregoing embodiments; or the picture-level syntax may be used as the higher-level unit syntax of the current coding unit to transmit the information in the foregoing embodiments; or the picture-level extension data syntax may be used as the higher-level unit syntax of the current coding unit to transmit the information in the foregoing embodiments; or the slice-level syntax may be used as the higher-level unit syntax of the current coding unit to transmit the information in the foregoing embodiments; or the tile-level syntax may be used as the higher-level unit syntax of the current coding unit to transmit the information in the foregoing embodiments; or the patch-level syntax may be used as the higher-level unit syntax of the current coding unit to transmit the information in the foregoing embodiments; or the LCU-level syntax may be used as the higher-level unit syntax of the current coding unit to transmit the information in the foregoing embodiments.

For example, the above embodiments may be implemented separately or in combination. For example, and at least two of Embodiment 1-Embodiment 15 may be implemented in combination. For example, in the foregoing embodiments, the contents of the encoder side may also be applied to the decoder side, i.e., the decoder side may adopt the same manner for processing, and the contents of the decoder side may also be applied to the encoder side, i.e., the encoder side may adopt the same manner for processing, which is not repeated here again.

Based on the same application concept as the foregoing method, an embodiment of the present disclosure further provides a picture decoding apparatus, where the apparatus is applied to a decoder side, and the apparatus includes: a memory, configured to store video data; and a decoder, configured to implement the decoding methods in Embodiment 1-Embodiment 15, i.e., a processing procedure of a decoder side. For example, in a possible implementation, the decoder is configured to:
when permission protection is enabled, determine one or more target region categories corresponding to a target permission level; and
decode the current coding unit according to the one or more target region categories.

Based on the same application concept as the foregoing method, an embodiment of the present disclosure further provides a picture encoding apparatus, where the apparatus is applied to a encoder side, and the apparatus includes: a memory, configured to store video data; and an encoder, configured to implement the encoding methods in Embodiment 1-Embodiment 15, i.e., a processing procedure of an encoder side. For example, in a possible implementation, an encoder is configured to:
determine one or more target region categories when permission protection is enabled, where the target region category is a region category corresponding to the first permission level and not corresponding to the second permission level;
encode the current coding unit according to the one or more target region categories.

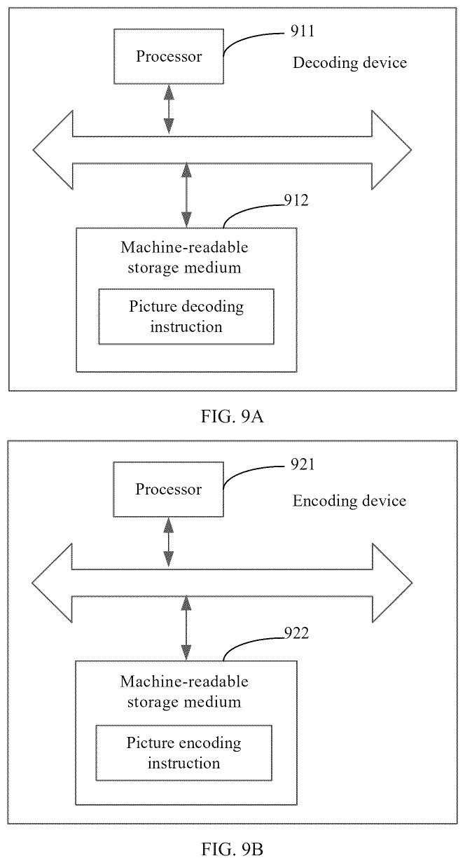

Based on a same application concept as the foregoing method, a decoder device (which may also be referred to as a video decoder) is provided in the embodiment of the present disclosure, and from the hardware perspective, its specific hardware architecture diagram may refer to FIG. 9A. The decoder device includes: a processor 911 and a machine-readable storage medium 912, where the machine-readable storage medium 912 stores machine-executable instructions (picture decoding instructions) that can be executed by the processor 911; and the processor 911 is configured to execute the machine-executable instructions to implement the picture decoding methods in Embodiment 1-Embodiment 15 of the present disclosure.

Based on a same application concept as the foregoing method, an encoder device (which may also be referred to as a video encoder) is provided in the embodiment of the present disclosure, and from the hardware perspective, its specific hardware architecture diagram may refer to FIG. 9B. The encoder device includes: a processor 921 and a machine-readable storage medium 922, where the machine-readable storage medium 922 stores machine-executable instructions (picture decoding instructions) that can be executed by the processor 921; and the processor 921 is configured to execute the machine-executable instructions to implement the picture encoding methods in Embodiment 1-Embodiment 15 of the present disclosure.

Based on a same application concept as the foregoing method, an embodiment of the present disclosure further provides a machine-readable storage medium, where the machine-readable storage medium stores several computer instructions, and when the computer instructions are executed by a processor, the method disclosed in the foregoing examples of the present disclosure, e.g., the picture decoding method or the picture encoding method in the foregoing embodiments, can be implemented.

Based on a same application concept as the foregoing method, an embodiment of the present disclosure further provides a computer application, and when the computer application is executed by a processor, a picture decoding method or a picture encoding method disclosed in the foregoing example of the present disclosure can be implemented.

Based on a same application concept as the foregoing method, an embodiment of the present disclosure further provides a picture decoding apparatus, where the apparatus is applied to a decoder side, and the apparatus includes: a processing module, configured to determine, when permission protection is enabled, one or more target region categories corresponding to a target permission level; and a decoding module, configured to decode a current coding unit based on the target region category.

For example, when decoding the current coding unit based on the target region category, the decoding module is specifically configured to: when decoding the current coding unit, if a target region category exists in one or more current region categories corresponding to the current coding unit, decode the first bit stream corresponding to the current coding unit, where the first bit stream includes high-dimensional reconstruction information of the current coding unit; and reconstruct the current coding unit based on the high-dimensional reconstruction information.

For example, when decoding the current coding unit according to the one or more target region categories, the decoding module is specifically configured to: when decoding the current coding unit, if the target region category does not exist in the one or more current region categories corresponding to the current coding unit, reconstruct the current coding unit based on low-dimensional reconstruction information.

For example, the low-dimensional reconstruction information is obtained by decoding the second bit stream corresponding to the current coding unit, the first bit stream is a bit stream obtained through decryption, and the second bit stream is a bit stream obtained without decryption.

For example, the processing module is further configured to: if the enable control information allows permission protection to be enabled, determine to enable the permission protection. The enable control information includes: enable control information at a sequence level or sequence level extension data; or enable control information at a picture level or picture level extension data; or enable control information at a slice level; or enable control information at a tile level; or enable control information at a patch level; or enable control information at an LCU level; or enable control information at a control unit level.

For example, if enable control information at multiple levels exists, the decoding module is further configured to: decode enable control information at a higher level; if the enable control information at the higher level does not allow permission protection to be enabled, determine not to enable the permission protection; if the enable control information at the higher level allows permission protection to be enabled, decode enable control information at a lower level; if the enable control information at the lower level does not allow permission protection to be enabled, determine not to enable the permission protection; and if the enable control information at the lower level allows permission protection to be enabled, and the enable control information at the lower level is enable control information at the last level, determining to enable the permission protection.

For example, the processing module is further configured to: acquire a region category identifier and region location information of one or more regions corresponding to the region category identifier; and for a current coding unit corresponding to the piece of region location information, determining a region category corresponding to the region category identifier as a current region category corresponding to the current coding unit.

For example, the processing module is further configured to acquire a total quantity of picture regions corresponding to the region category identifier; and when acquiring the region location information of one or more regions corresponding to the region category identifier, the processing module is specifically configured to acquire the region location information of the total quantity of picture regions corresponding to the region category identifier, where the total quantity of the picture regions is not greater than a preset quantity threshold.

For example, when acquiring the region category identifier and the region location information of one or more regions corresponding to the region category identifier, the processing module is specifically configured to: decode the region category identifier and the region location information of one or more regions corresponding to the region category identifier from the higher-level unit syntax of the current coding unit; and when acquiring the total quantity of picture regions corresponding to the region category identifier, the processing module is specifically configured to: decode the total quantity of picture regions corresponding to the region category identifier from the higher-level unit syntax of the current coding unit.

For example, the region location information is region location information of a polygonal region, a rectangular region, or a circular region; for the polygonal region and the rectangular region, the region location information includes at least one vertex coordinate relative to a preset origin; and for the circular region, the region location information includes center coordinate and a radius of a circular region relative to a preset origin.

For example, a plurality of picture units are arranged in a preset scanning order, and the region location information includes a start picture unit index and an end picture unit index relative to a preset origin; or the region location information includes a start picture unit index relative to a preset origin and a total quantity of picture units in a current region; or the region location information includes an end picture unit index relative to a preset origin and a total quantity of picture units in a current region.

For example, if the region category identifier corresponds to region location information of a plurality of regions, using an end picture unit of region location information of a previous region as a preset origin corresponding to region location information of a current region.

For example, the picture unit is a coding unit, or the picture unit is an A*B picture unit obtained through division in a preset division manner, A is greater than or equal to a minimum size of the coding unit, and B is greater than or equal to the minimum size of the coding unit.

For example, the processing module is further configured to: acquire a combination identifier corresponding to the region category identifier, where the combination identifier indicates whether an associated region category identifier of a combination operation with the region category identifier exists; and if the combination identifier indicates that the associated region category identifier of the combination operation with the region category identifier exists, acquire the associated region category identifier corresponding to the region category identifier.

For example, the processing module is further configured to, for the coding unit corresponding to the region location information corresponding to the associated region category identifier, determine the region category corresponding to the region category identifier and the region category corresponding to the associated region category identifier as the region category corresponding to the coding unit.

The permission level corresponding to the associated region category identifier is equal to the permission level corresponding to the region category identifier; or the permission level corresponding to the associated region category identifier is lower than the permission level corresponding to the region category identifier.

For example, the processing module is further configured to acquire a total quantity of category identifiers corresponding to the associated region category identifiers; and when acquiring one or more associated region category identifier corresponding to the region category identifier, the processing module is specifically configured to acquire the one or more associated region category identifiers as many as the total quantity of category identifiers corresponding to the region category identifier.

For example, when acquiring the combination identifier corresponding to the region category identifier, the processing module is specifically configured to decode the combination identifier corresponding to the region category identifier from the higher-level unit syntax of the current coding unit; when acquiring the associated region category identifier corresponding to the region category identifier, the processing module is specifically configured to decode the associated region category identifier corresponding to the region category identifier from the higher-level unit syntax of the current coding unit; and when acquiring the total quantity of category identifiers corresponding to the associated region category identifier, the processing module is specifically configured to decode the total quantity of category identifiers corresponding to the associated region category identifier from the higher-level unit syntax of the current coding unit.

For example, the processing module is further configured to: acquire a region category identifier corresponding to each picture unit; and determine, based on a region category identifier corresponding to a picture unit covered by the current coding unit, a region category corresponding to a highest permission level in the region category identifier as the current region category corresponding to the current coding unit.

For example, when acquiring the region category identifier corresponding to each picture unit, the processing module is specifically configured to: acquire the region category identifier and region indication information, where the region indication information indicates a plurality of picture units, and determine the region category identifier as the region category identifier corresponding to the plurality of picture units, where the region indication information includes start point coordinates relative to a preset origin, at least one direction identifier, a length corresponding to each direction identifier, and an end flag, the start point coordinates indicate a picture unit corresponding to the region category identifier, the direction identifier indicates a direction of a picture unit that belongs to a same region category, the length corresponding to each direction identifier indicates a quantity of picture units in the direction of the picture unit that belongs to the same region category, and the end flag indicates that the plurality of picture units have been completed.

For example, the length corresponding to each direction identifier is fixed to 1.

For example, when acquiring the region category identifier corresponding to each picture unit, the processing module is specifically configured to: determine a target shape enclosed by the plurality of picture units indicated by the region indication information; and determine the region category identifier as the region category identifier corresponding to the picture unit in the target shape.

For example, the preset origin is an upper-left corner point obtained by dividing a preset M*N rectangle, or the preset origin is obtained by decoding a bit stream. The preset M*N rectangular division is an LCU division.

For example, when acquiring the region category identifier corresponding to each picture unit, the processing module is specifically configured to, decode the region category identifier corresponding to each picture unit from the higher-level unit syntax of the current coding unit.

For example, the higher-level unit is an LCU, patch, slice, tile, picture, or sequence in which the current coding unit is located.

For example, when determining one or more target region categories corresponding to the target permission level, the processing module is specifically configured to: query a mapping relationship by using the target permission level and the candidate permission level, to obtain a region category corresponding to the target permission level and a region category corresponding to the candidate permission level, and determine the region category corresponding to the target permission level and the region category corresponding to the candidate permission level as the target region categories corresponding to the target permission level, where the candidate permission level is a permission level lower than the target permission level, and the mapping relationship includes a correspondence between permission levels and region categories.

Based on a same application concept as the foregoing method, an embodiment of the present disclosure further provides a picture encoding apparatus, where the apparatus is applied to an encoder side, and the apparatus includes: a processing module, configured to determine one or more target region categories when permission protection is enabled, where the target region category is a region category corresponding to the first permission level and not corresponding to the second permission level; and an encoding module, configured to encode a current coding unit based on the target region category.

For example, when encoding the current coding unit based on the target region category, the encoding module is specifically configured to: when encoding the current coding unit, if a target region category exists in one or more current region categories corresponding to the current coding unit, encode the first bit stream and the second bit stream corresponding to the current coding unit, where the first bit stream includes high-dimensional reconstruction information of the current coding unit, and the second bit stream includes low-dimensional reconstruction information of the current coding unit.

A person skilled in the art should understand that the embodiments of the present disclosure may be provided as a method, a system, or a computer program product. The present disclosure may use a form of a fully hardware embodiment, a fully software embodiment, or a combination of software and hardware embodiments. The embodiments of the present disclosure may use a form of a computer program product that is implemented on one or more computer-usable storage media (including, but not limited to, a disk memory, a CD-ROM, an optical memory, etc.) that include computer-usable program code.

The foregoing descriptions are merely embodiments of the present disclosure and are not intended to limit the present disclosure. For those skilled in the art, the present disclosure may have various modifications and variations. Any modification, equivalent replacement, or improvement made without departing from the spirit and principle of the present disclosure shall fall within the scope of the claims of the present disclosure.

1. A picture decoding method, performed by a decoding device, wherein the method comprises:
when permission protection is enabled, determining one or more target region categories corresponding to a target permission level; and
decoding a current coding unit according to the one or more target region categories.

2. The method according to claim 1, wherein decoding the current coding unit according to the one or more target region categories comprises:
when decoding the current coding unit, in response to determining that the one or more target region categories exist in one or more current region categories corresponding to the current coding unit, decoding a first bit stream corresponding to the current coding unit, wherein the first bit stream comprises high-dimensional reconstruction information of the current coding unit; and
reconstructing the current coding unit based on the high-dimensional reconstruction information.

3. The method according to claim 2, wherein decoding the current coding unit according to the one or more target region categories comprises:
when decoding the current coding unit, in response to determining that none of the one or more target region categories exists in the one or more current region categories corresponding to the current coding unit, reconstructing the current coding unit based on low-dimensional reconstruction information.

4. The method according to claim 3, wherein
the low-dimensional reconstruction information is obtained by decoding a second bit stream corresponding to the current coding unit;
the first bit stream is a bit stream obtained through decryption; and
the second bit stream is a bit stream obtained without decryption.

5. The method according to claim 1, wherein
in response to determining that enable control information allows the permission protection to be enabled, determining to enable the permission protection.

6. The method according to claim 5, wherein the enable control information comprises: enable control information at a sequence level; or enable control information at a picture level.

7. The method according to claim 5, wherein the method comprises:
in response to determining that there is the enable control information at multiple levels, decoding the enable control information at a higher level;
in response to determining that the enable control information at the higher level does not allow the permission protection to be enabled, determining not to enable the permission protection;
in response to determining that the enable control information at the higher level allows the permission protection to be enabled, decoding the enable control information at a lower level;
in response to determining that the enable control information at the lower level does not allow the permission protection to be enabled, determining not to enable the permission protection; and
in response to determining that the enable control information at the lower level allows the permission protection to be enabled, and the enable control information at the lower level is the enable control information at a last level, determining to enable the permission protection.

8. The method according to claim 2, wherein before determining that the one or more target region categories exist in one or more current region categories corresponding to the current coding unit, the method further comprises:
acquiring a region category identifier and one or more pieces of region location information corresponding to the region category identifier; and
for a current coding unit corresponding to the region location information, determining a region category corresponding to the region category identifier as a current region category corresponding to the current coding unit.

9. The method according to claim 8, wherein
before acquiring one or more pieces of region location information corresponding to the region category identifier, the method further comprises:
acquiring a total quantity of picture regions corresponding to the region category identifier; and
acquiring one or more pieces of region location information corresponding to the region category identifier comprises:
acquiring the one or more pieces of region location information as many as the total quantity of the picture regions corresponding to the region category identifier;
wherein the total quantity of the picture regions is not greater than a preset quantity threshold.

10. The method according to claim 8, wherein
acquiring a region category identifier and one or more pieces of region location information corresponding to the region category identifier comprises:
decoding the region category identifier and the one or more pieces of region location information corresponding to the region category identifier from higher-level unit syntax of the current coding unit; and
acquiring a total quantity of picture regions corresponding to the region category identifier comprises:
decoding the total quantity of picture regions corresponding to the region category identifier from the higher-level unit syntax of the current coding unit.

11. The method according to claim 8, wherein
the region location information is region location information of a rectangular region;
for the rectangular region, the region location information comprises coordinates of at least one vertex relative to a preset origin.

12.-23. (canceled)

24. The method according to claim 11, wherein
the preset origin is an upper-left corner point of a preset M*N rectangle division, or
the preset origin is obtained by decoding a bit stream.

25. The method according to claim 24, wherein
the preset M*N rectangular division is an LCU division.

26. (canceled)

27. The method according to claim 10, wherein a higher-level unit is a picture or a sequence in which the current coding unit is located.

28.-30. (canceled)

31. A picture decoding apparatus, applied to a decoding device, wherein the apparatus comprises:
a memory, configured to store video data;
a decoder, configured to:
when permission protection is enabled, determine one or more target region categories corresponding to a target permission level; and
decode a current coding unit according to the one or more target region categories.

32. (canceled)

33. A decoding device, comprising: a processor and a machine-readable storage medium, wherein the machine-readable storage medium stores machine-executable instructions executable by the processor; and the processor is configured to execute the machine-executable instructions to perform operations comprising:
when permission protection is enabled, determining one or more target region categories corresponding to a target permission level; and
decoding a current coding unit according to the one or more target region categories.

34. (canceled)

35. The decoding device according to claim 33, wherein the processor is further configured to:
when decoding the current coding unit, in response to determining that the one or more target region categories exist in one or more current region categories corresponding to the current coding unit, decode a first bit stream corresponding to the current coding unit, wherein the first bit stream comprises high-dimensional reconstruction information of the current coding unit; and
reconstruct the current coding unit based on the high-dimensional reconstruction information.

36. The decoding device according to claim 35, wherein the processor is further configured to:
when decoding the current coding unit, in response to determining that none of the one or more target region categories exists in the one or more current region categories corresponding to the current coding unit, reconstruct the current coding unit based on low-dimensional reconstruction information.

37. The decoding device according to claim 36, wherein
the low-dimensional reconstruction information is obtained by decoding a second bit stream corresponding to the current coding unit;
the first bit stream is a bit stream obtained through decryption; and
the second bit stream is a bit stream obtained without decryption.

38. A non-transitory machine-readable storage medium, wherein the non-transitory machine-readable storage medium stores several computer instructions, and when the computer instructions are executed by a processor, the method according to claim 1 is implemented.
